(19) United States
(12) Patent Application Publication
(10) Pub. No.: US 2002/0052853 A1
(43) Pub. Date: May 2, 2002

(54) Transportation system for on-line transactions

(76) Inventor: Fernando Munoz, Brooklyn, NY (US)

Correspondence Address: DARBY & DARBY P.C., 805 Third Avenue, New York, NY, 10022, US

(21) Appl. No.: 09/781,714

(22) Filed: Feb. 12, 2001

Related U.S. Application Data
(60) Provisional application No. 60/181,570, filed on Feb. 10, 2000.
(60) Provisional application No. 60/188,731, filed on Mar. 13, 2000.
(60) Provisional application No. 60/194,430, filed on Apr. 4, 2000.
(60) Provisional application No. 60/197,284, filed on Apr. 14, 2000.
(60) Provisional application No. 60/211,327, filed on Jun. 12, 2000.
(60) Provisional application No. 60/241,949, filed on Oct. 20, 2000.

(51) Int. Cl. G06F 17/60

(52) U.S. Cl. 705/79

(57) ABSTRACT

What is disclosed in this application is: an Internet payment system. An Internet payment system comprising a user device with a processor, Internet connection apparatus and an Internet browser. The Internet payment system also includes a participating merchant server supporting web pages on which product or service offerings are displayed in response to queries from the user device using the connections apparatus and browser. The merchant server interacting with the user device browser permits a user to select at least one offering and to indicate a method of payment, at least one method of payment being a transfer link. The Internet payment system also comprises a participating financial institution server maintained by a financial institution at which the user has a financial account. The server permits the user to gain direct access to his financial account. In addition, the Internet payment system includes a main transportation server to which both the user device and merchant server are connected in response to the user selecting the transfer link as the method of payment. The merchant server transmits information to the main transport server regarding payment required for the selected offering and the main transport server provides a selection of financial institutions from which the user can select an institute at which he has an account for payment for the offering. The main transport server transmits user inputs directly to the financial institution server to authorize payment to the merchant for the offering without storing the inputs.

### CROSS-REFERENCE TO RELATED APPLICATIONS

This application claims the benefit of priority from provisional U.S. Patent Application Serial No. 60/181,570 entitled “Security System for Financial Transactions Online,” filed Feb. 10, 2000; Ser. No. 60/188,731, entitled “Security System for Financial Transactions Online,” filed on Mar. 13, 2000; Ser. No. 60/194,430 entitled “Security System for Financial Transactions Online,” filed on Apr. 4, 2000, Ser. No. 60/197,284 entitled “Security System for Financial Transactions Online,” filed on Apr. 14, 2000, Ser. No. 60/211,327 entitled “Security System for Financial Transactions Online,” filed on Jun. 12, 2000, Ser. No. 60/241,949 entitled “Security System for Financial Transactions Online” filed on Oct. 20, 2000, the disclosures of which are incorporated herein by reference in its entirety.

### BACKGROUND OF THE INVENTION

1. Field of the Invention

The invention relates generally to the field of confidential document transport. More particularly, the invention relates to a system and method for networking computer systems with enhanced security architecture to deliver real time payments and documentation among financial institutions, merchants, corporations and consumers.

2. Description of Related Art

Consumers, merchants and financial institutions need more efficient and comprehensive on-line payment methods. Currently available distributed computer network or on-line payment systems are complicated to use. A popular current system requires user registration with payment agents. These agents are provided by the customer with information on bills to be paid as well as with the already amounts paid. Frequently, the customer will supply information about the customer's financial institution accounts from which payment will be made. The payment solutions offered by these agent intermediaries clearly reflect an exposure of confidential information. In addition, there exists few alternatives to these payment “agents.”

Almost all merchants fulfill transactions on-line using credit cards. This requires the user to transmit credit card account information on the Internet. Even when this information is encrypted, there is a risk of exposure.

Wallets and digital tokens are the most popular alternatives to credit cards. These alternative market solutions to credit cards are based on a “prior identification” request. Hence wallets and digital currencies “protect” users' confidential information by first forcing consumers to disclose confidential information to them, even though this information may not be subsequently transmitted over the Internet. Thus, from a security standpoint, wallets are problematic.

Traditional financial institutions are at risk of having their consumer base eroded by emerging on-line competitors, who are driving the shift in the delivery of financial products and services from the traditional physical infrastructure to electronic channels. Thus, the industry is in transition. The electronic wallet solves part of this problem. However, the weakness in the wallet, as well as other sites, is that highly confidential information is concentrated in one source. This source is in most cases in hands of companies with commercial interests. This single source is vulnerable to hackers who can expose millions of users to attacks and who can potentially create proprietary financial market niches. Additionally, wallet proprietors share users' behavioral information with merchants, which erode privacy rights. All existing financial on-line solutions require users to sign up in their systems before they can operate.

Another popular on-line financial concept is a “digital check”, a digital version of a paper check, where issuers such as CheckFree send users' digital checks to an Automated Clearing House (“ACH”). The ACH then processes and presents digital checks to the financial institution for approval as a regular check. Users most show proof of identification to the wallet, digital check issuer or digital token company as a proprietary measure in order to establish their commercial franchise. Again, the confidential information of the user is widely distributed.

### SUMMARY OF THE INVENTION

The present invention is directed to providing a system by which a user can authorize the payment of funds from his financial institution to a merchant of goods or services without transmitting confidential fmancial information to any source by his own financial institution.

The present invention provides users with immediate access to their on-line financial accounts. These accounts include, but are not limited to, credit cards, savings, checking, store value, and any financial account. Users conduct financial transactions simply by logging directly onto a particular financial institution's network, be it through the distributed computer network or other such network links. The user directly initiates the financial institution's identification and approval process. In addition, the present invention liberates users from the necessity of filling out on-line purchase forms because the system of the present invention automatically sends this information with the consent of the user from the user's financial institution files. This system, thus opens the financial institution's doors to users for both business and individual purposes without exposing confidential information.

With the present invention, the user is in direct contact with his/her account as opposed to sending account information to a third party. The present invention is not only a full payment system, but an armored data transportation system. In addition, the present invention works as a “financial browser,” providing access to various financial products and services. In this connection, the system is compatible with payment systems such as credit cards and smart cards (e.g. cards with chip or digital cash- tokens). The benefit of this compatibility is that the combination of these technologies can improve the business and organizational operations of retail corporations, financial organizations, and individuals alike. Using the same system's components, the invention can securely send confidential documentation between companies or organizations. To gain access to this information, the system may require use of a smart card. In the same matter, this card may limit the access and expenditure of company funds (depending on internal company policies) as well as the identification utensils.

One of the advantages of the invention is the ability to generate payment instructions to apply to business operational requirements, such as drafts, bills of exchange or any other regulated document. Another advantage of the present invention is the top security measures utilized. Upon access to the system, users enter a security mode. Encryption and packaging systems, such as Puzzle Packaging System (“PPS”) described below, and current market encryption systems, such as SSL, secure transactions in transportation from origin to destination. These modules create packages such as VMP (“Virtual Money Packet”) or VDP (“Virtual Document Packet”) for document transportation with instructions and transaction information. VMPs transport information including, but not limited to, user and merchant financial institution identification, account numbers, routing information, type of money involved, Global Transaction Link (“GTL”), Transaction Instruction Sets (“TIS”), serial numbers and merchant financial information. VDPs transport information including, but not limited to, user identification, user and merchant financial institution identification, account numbers, routing information, confidential files, transaction time, GTL/TIS, and serial numbers. The present invention sends the user directly to the financial institutions' internal networks. Upon entering the financial institution network, users will benefit from the financial institution's security measures already in place. These institutions spend enormous amounts of resources on security issues. Users are in security mode from the moment the user taps onto the present invention's network until the moment the user exits the system.

The present invention can be used in conjunction with Puzzle Packaging System (“PPS”) which is a new concept in logical data encryption. This encryption technique varies from mathematical based encryption systems which use complex mathematical algorithms to encrypt messages. PPS works in conjunction with current encryption systems such as SSL. In standard distributed computer network communication systems using TCP/IP, information is packed into small packets. Each packet is routed to a destination computer using the shortest possible route. PPS can encrypt any type of digital information including TCP/IP packets. PPS is not dependent on the content. Instead, PPS checks a file's size. PPS then takes the information and divides the digital data into multiple packets. Each packet is then encoded with special encrypted markings that point to the packet's original location in the original data file. The system then may generate a number of false packets which will be sent with the real packets. False packets boost security levels by distracting a potential hacker from the real packets. The PPS system then scrambles the generated packets to create a virtual puzzle. When the information leaves PPSs original location it is also encrypted using an encryption method such as the SSL system. Then, using more than one IP addresses, the PPS system sends the packets thru available IP addresses in random order. PPS logic randomly determines which IP addresses to use from the PPS origin to the PPS destination in the system. Because PPS uses more than one IP address, it becomes harder to grab information from one place. In addition, PPS dices the data and scrambles the original order. Even if one IP address was used, the information is received in totally random order and cannot be used until it is reassembled using special reassemble sequences and methods.

Each and every packet must be decoded when the packets arrive at the original location in the original file. The decoding process allows the system to reintegrate the message and disclose the details inside. To open a message, the system needs 100% of the generated packets. Otherwise, there is no way to reassemble the components without the full code. An opening code is spread out over each packet, which explains why it is impossible to open packets without receiving all of them. As more IP addresses are used, the security of the system grows. PPS modules monitor all activity preformed on packets in traffic, origin or destination, without actually accessing the confidential information contained within the packet.

The present invention links users and merchants by organizing and transporting the path for requests of payment and confirmations of transactions to and from respective fmancial institutions. In opposition to other payment methods, the transportation sever never stores information about or takes possession of the user's funds. Financial institutions verify transactions and either approve or deny them. The present invention, using network connected devices, delivers or presents bills to users such as merchants as well as users such as bill collectors. The present invention provides merchants with the ability to generate bills, already prepared with a link to access the system's network so users can fulfill payment themselves. Merchants now exhaust many resources in their efforts to pay bill collectors. With the system of the present invention, merchants will save costs and protect their clients' private information from being shared with bill collectors.

The invention also allows users to transfer funds between accounts. Users input their destination account and their financial institution authorizes the transfer of funds. This fund transfer can also be to open a new account in a different financial institution. Some examples of network connected devices include, but are not limited to, computers, hand-held computing devices, phones, in-shop merchant payment terminals and ATMs on-line or in physical locations.

### BRIEF DESCRIPTION OF THE DRAWINGS

The foregoing and other features of the present invention will be more readily apparent from the following detailed description and drawings of illustrative embodiments of the invention wherein like reference numbers refer to similar elements throughout the several views and in which:

FIG. 1 is a block diagram of a network arrangement useful for implementing an exemplary embodiment of the present invention;

FIG. 2 is a further block diagram of a network arrangement useful for implementing another embodiment of the present invention wherein a fmancial institution's remote server houses the main transportation server;

FIG. 3 is another exemplary block diagram of a network arrangement useful for implementing a further embodiment of the present invention wherein a series of financial institutions house the main transportation server;

FIG. 4a represents an exemplary function list for a main server as seen in FIGS. 1-3;

FIG. 4b represents an exemplary block diagram and function list for a financial institution's application server useful for implementing the present invention;

FIG. 5a represents an exemplary dynamic interface or Web page generator of the main transportation server as seen in FIGS. 1-3;

FIG. 5b represents an exemplary block diagram and function list for a merchant's application server useful for implementing the present invention;

FIG. 6 is a flowchart depicting a process for payment of a bill in accordance with an exemplary embodiment of the present invention;

FIG. 7 is a flowchart depicting a process for funds transfer in accordance with an exemplary embodiment of the present invention;

FIG. 8 is a flowchart depicting a process for funds transfer between financial institutions in accordance with an exemplary embodiment of the present invention;

FIG. 9 is a flowchart depicting a process for funds transfer amongst multiple financial institutions in accordance with an exemplary embodiment of the present invention;

FIG. 10 is a flowchart depicting a process for encrypted file transfers in accordance with an exemplary embodiment of the present invention;

FIG. 11 is an exemplary purchase Web page in accordance with the present invention;

FIG. 12a is an exemplary banking institution selection Web page accessed from FIG. 11;

FIG. 12b is an exemplary banking institution login Web page accessed from FIG. 12a;

FIG. 12c is a further banking institution account login Web page accessed from FIG. 12b;

FIG. 12d is an exemplary merchant confirmation selection Web page accessed from FIG. 12c;

FIG. 12e is a further merchant confirmation Web page accessed from FIG. 12d;

FIG. 12f is an exemplary further security measure Web page accessed from FIG. 12e;

FIG. 12g is an exemplary user entered ID confirmation Web page accessed from FIG. 12e;

FIG. 12h is an exemplary financial institution account balance listing Web page;

FIG. 12i is an exemplary processing transaction Web page depicting the PPS system;

FIG. 12j is an exemplary transaction approval Web page;

FIG. 13a is an exemplary credit card institution selection Web page accessed from FIG. 11;

FIG. 13b is another exemplary credit card institution login Web page similar to that seen in FIG. 12b;

FIG. 13c is an example of a further security measure provided at the financial institution's login Web page;

FIG. 13d is another exemplary merchant confirmation selection Web page;

FIG. 13e is an exemplary user entered ID confirmation Web page accessed from FIG. 13d ;

FIG. 13f is an exemplary processing transaction Web page depicting the PPS system, similar to that depicted in 12i;

FIG. 13g is an exemplary transaction approval Web page;

FIG. 14a is an exemplary associated account smart card selection Web page accessed from FIG. 12a;

FIG. 14b is an exemplary login screen Web page for the associated smart card;

FIG. 15 is an exemplary bill presentment Web page in accordance with a exemplary embodiment of the present invention;

FIG. 15a is a further exemplary bill presentment Web page in accordance with the present invention;

FIG. 16a is an exemplary credit card institution selection Web page accessed from FIG. 15a;

FIG. 16b is an exemplary credit card institution login Web page;

FIG. 16c is an exemplary processing transaction Web page depicting the PPS system;

FIG. 16d is an exemplary bill presentment transaction approval Web page;

FIG. 17a is an exemplary bank financial institution selection Web page accessed from the bill presentment Web page in FIG. 15a;

FIG. 17b is an exemplary banking institution account login screen Web page accessed from FIG. 17a;

FIG. 17c is an exemplary financial institution account balance listing Web page;

FIG. 17d is an exemplary processing transaction Web page depicting the PPS system;

FIG. 17e is an exemplary bill presentment transaction approval Web page;

FIG. 18a is an exemplary associated account smart card selection Web page accessed from FIG. 16a or 17a;

FIG. 18b is an exemplary login screen Web page for the associated smart card;

FIG. 19a is an example of normal transaction request graphics for the adaptive security system; and

FIG. 19b is an example of illegal transaction request graphics for the adaptive security system.

### DETAILED DESCRIPTION OF THE EXEMPLARY EMBODIMENTS

By way of overview and introduction, an exemplary embodiment of the present invention is a distributed computer network payment system. This system generally involves at least three parties: a customer, a merchant, and a financial institution. A separate payment agent is not necessary. The transactions amongst the parties are secured through an encryption/decryption technique, an adaptive security system which monitors transaction requests involving system servers and a firewall identified as the guardian system.

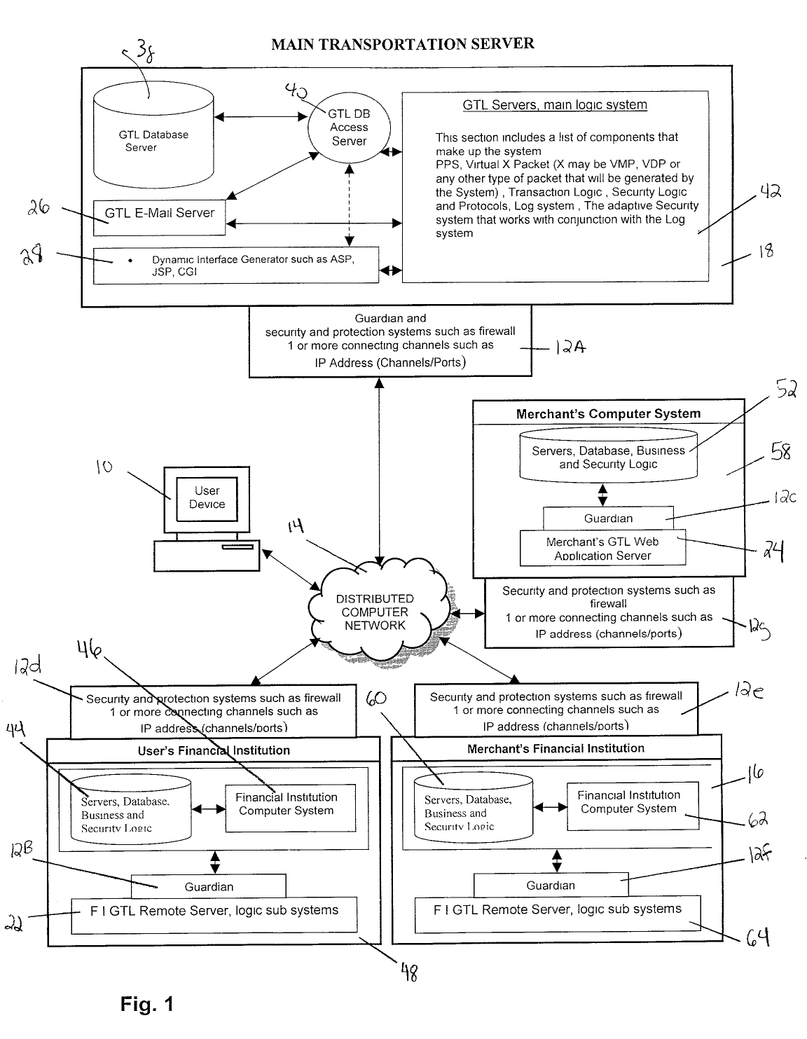

FIG. 1 depicts a block diagram of a network arrangement useful for implementing an exemplary embodiment of the present invention. In FIG. 1, a network arrangement of distributed computers is illustrated in which users at a user device 10 operate a conventional Web browser, such as those commercially available from Microsoft Corporation of Redmond, Washington under the name Internet Explorer or from Netscape Communications, Inc. of Mountain View, California under the name Communicator. There can be a plurality of user devices 10 all connected through a distributed computer network 14, e.g., the Internet.

The system accessed by the user device 10 includes a Merchant's Computer system 58 which includes a Merchant's application server 24 that runs part of the Global Transport Logic (GTL) software for operating the system. The system also includes a Financial Institution computer system 46 which includes a Financial Institution Application Server that runs part of the GTL software for the system. Finally, there is a main transportation server 18 configured to implement the secured document or payment transportation system.

A customer at user device 10, which may be a personal computer with an Internet connection, accesses the merchant's computer system 58 over the Internet 14 in an effort to find and purchase a product or service. This is accomplished by inserting the URL for the merchant in a web browser running on the PC 10. The customer is linked to the merchant site through a firewall 12G and gains access to the merchant's website. In response, the merchant's computer system will display typical web pages on which its products and services are offered. These pages are supported by various servers and databases 52 of conventional form. This also includes conventional security measures. Using the browser the customer can search through the offerings and those in which he would like to purchase. Then, the merchant requests that the customer select a method of payment.

The customer can pay in conventional ways offered by the merchant. However, the customer will also be presented with the opportunity to pay by a link transfer as achieved with the present invention. This transfer is made available to the customer through the merchant's GTL software running on the Merchant's application server 24. However, this software is accessed through a Guardian module 12C which acts to monitor access to this portion of the system and creates additional security. It can also be used to secure useful information on system operation.

Selecting the transfer link method causes the GTL software at the merchant to link the customer to the main transportation system server 18. In response the main transportation server 18 provides the customer a Web page shown on the display screen at the user device 10. The Web page includes a number of elements which prompt the user and guides him or her to further information available from the main transportation server 18.

The main transportation server 18 houses an email server 26 and a dynamic transportation interface generator 28. In addition to accessing the main transportation server 18 via a merchant's web application server 24, they may also directly access it through the distributed computer network 14. The security system 12A acts as a firewall for the main server.

The web pages from the main server 18 present the customer with a list of available transfer link institutions which participate in the system. These include credit card companies and banks. The user selects one where he has an account, e.g., financial institutions 44, and the main server links the customer directly to a login screen for that institution. This is presented to the user as part of the web page created by generator 28. At the same time, the merchant's server provides information about the invoice for the selected product or service offering, e.g., an identification of the goods and the price.

The customer now acts over a communications path that extends from the user device 10 to the main transportation server 18 and then to the financial institution application 22, without involving the merchant site. As a result, the transfer of confidential information to the financial institution does not go to the merchant. Also, the main server 18 merely sets up the link and does not intercept or store any of this information.

When linked to the financial institution server 46, the user must log on to get past a security fire wall 12D in the normal fashion, except that the input code is entered on the web page generated by generator 28 in the main server 18 of the system. Then the customer is linked through another guardian unit 12B to the financial institution server 22 which contains the GTL software. As is common, the financial institution computer system includes servers, databases and security 44.

The user continues to interact with the financial institution to authorize the payment of the invoice from the merchant. Then confirmation of the transfer is provided to the merchant and the user. In the case of the user, the confirmation may be by way of an e-mail sent to e-mail server 26, which is accessible by the user.

In a preferred embodiment, the authorization of payment is accompanied by a real time transfer of funds from the User's financial institutions 48 to the Merchant's financial institution 16. This can be by way of an electronic funds transfer or by means of a virtual money packet as described in more detail below. At the computer system of the institution 16 there are the usual servers, databases and security 60. Access to this system through a fire wall 12E is provided by the merchant in order to receive payment. Then access to the Merchant's Financial Institution application server 64, which runs the GTL software, is through the guardian module 12F, which performs the same function as the other guardian modules.

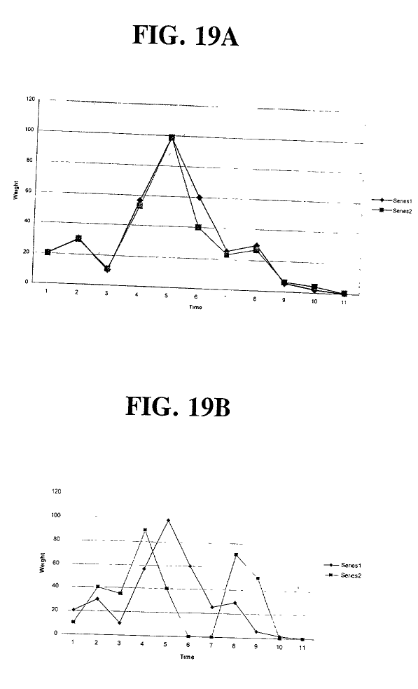

The security system comprising modules 12A, 12B, 12C, 12D, 12E, or 12F uses firewall intrusion detection techniques. Also, one component of the main transportation server 42 is an adaptive security system which analyzes transaction requests and creates historical patterns. Every transaction request involving the main transportation server 18, the merchant's web application server 24, or the financial institution's remote server 22 will be monitored by the main transportation server 42. Each component use is given a specific weight which can be negative or positive. A graph is generated which then displays both the time of an action and that action's specific weight. FIG. 19A (below) depicts such a graph. The advantage of the guardian model of the present invention is that current user's activity is matched against past user activity. If participating components are activated in a way that is different from usual transaction activity, the adaptive security system generates a warning. Past transaction requests are in effect a representation of what a server usually does at a particular time in a transaction. Each new transaction requests is compared with a prior transaction request and the main transportation server 42 therefore can detect sudden changes of behavior. Because the adaptive security system works with transaction request patterns, false alarms are detected by evaluating the type and seriousness of the behavior change. FIG. 19B (below) depicts illegal transaction behavior.

In addition to the adaptive security system, the main transportation server 42 also comprises an virtual document system. The virtual document system is responsible for encrypting and decrypting routing information amongst the parties, namely the merchant web application server 24, the financial institution's remote server 22 and the user. In essence, whenever a user transacts with a party within the system, an encrypted document packet is created. The encrypted document packet contains elements which help to decrypt a document packet and which determine how the elements are queried in a database. A software module accepts queries of the encrypted document packet. The software module then accesses the database to decrypt the document packet and to determine routing information for the virtual document packet. The document packet system then sends the virtual document packet to the interested party using PPS and many various IP addresses, whether that destination address is the merchant's financial institution's web application server 16 or the financial institution's remote server 22.

Thus, a basic model, customer-users log on to a merchant's web site to initiate a purchase. Once the user selects the purchase, the customer-user initiates payment authorization. At this point, should the user not have a smart card, the system presents the customer-user with a list of affiliated financial institutions. The customer then selects a financial institution with which the customer-user holds an account. At this point, the interface depicted can be customized for a particular user. The system then routes the customer-user directly to the log on screen of the associated financial institution. The Web site frame, which is graphics independent displays information from the merchant's Web site in one frame or screen portion and the financial institution's Web site information in a second frame or screen portion. The customer authorizes payment directly onto the financial institution's web site. The merchant, the customer, and the fmancial institution all receive encrypted confirmations of the transaction.

Beneath the user interface is an encrypted document delivery system. On the merchant-user's side, the system can provide, depending on necessity, encryption techniques for invoice identification, merchant identification, receipt of virtual money packets for the merchant's financial institution, and routing information. On the fmancial institution's side, the system provides encryption techniques for account holder identification, routing information and virtual money packets. For the customer, confirmations are encrypted and sent to each involved party, namely the associated financial institution, the merchant, and the user.

The secured document transportation system operated by the main transportation server 18 is established by software using tables in a relational database. A processor accesses the relational database and pulls together disparate elements into a hypertext page for presentation on a distributed computer network. Using a query-driven software engine, visitors can navigate a Web site with requested information being dynamically rendered with the user's movements (i.e. via mouse clicks) within the secured document transportation system. The software engine evaluates the user's current transportation interface or Web page in relation to the desired transportation interface by using predefined criteria maintained in the database.

The query-driven application uses a series of tables which, in the presently exemplary embodiment, are part of a relational database written in SQL or other such language such as Oracle. The information stored in the tables populates one of several templates which define a hypertext file. The software processor conveys the hypertext file to a user at a user device 10. As the user interacts with each page and makes a request to the server, a specific query is submitted to the server. This specific query causes one or more queries to be processed by the relational database. The relational database, in turn, responds to the specific queries with a list of potential transportation interfaces or Web pages. This information is combined with a selected HTML template using a scripting language such as JAVA Script, Perl or VBScript. The combined file which can be gathered from a plurality of sources is then transmitted back to the client-side server.

In a second embodiment of the present invention a confidential file transfer system is provided for. Generally, the parties involved in the file transfer system are two institutions. The first party logs into the system and indicates a document which the party wishes to transfer and to whom. The system then encrypts the document and sends the file to the second party. The second party must log onto the system in order to receive the decrypted document from the first party. If “log in” is successful, the system decrypts the document.

Preferably, the secured document transportation system on the users side employs an open architecture type operating system. This allows the load to be distributed as more servers are added to the system. In addition, the RAID (“Redundant Array of Inexpensive Disks”) approach can be used as the storage method. The RAID approach is a method of combining several hard drives into one unit. It offers fault tolerance and higher throughput levels than a single hard drive or group of independent hard drives. Further, communication on the distributed computer network will be hastened by using optic connections.

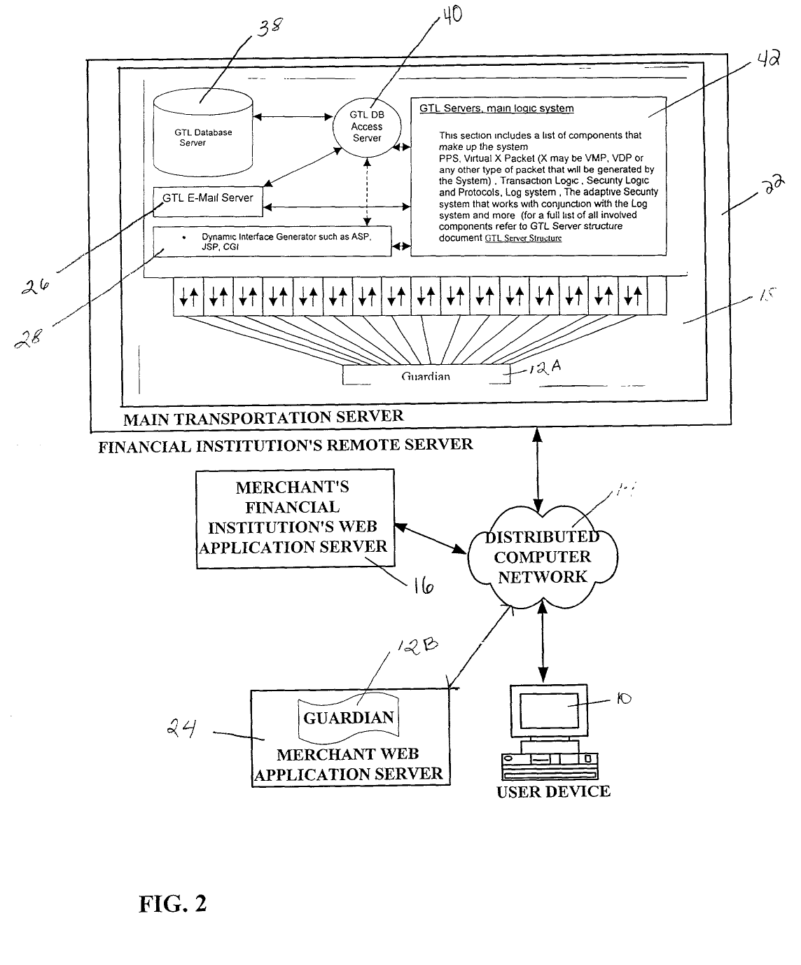

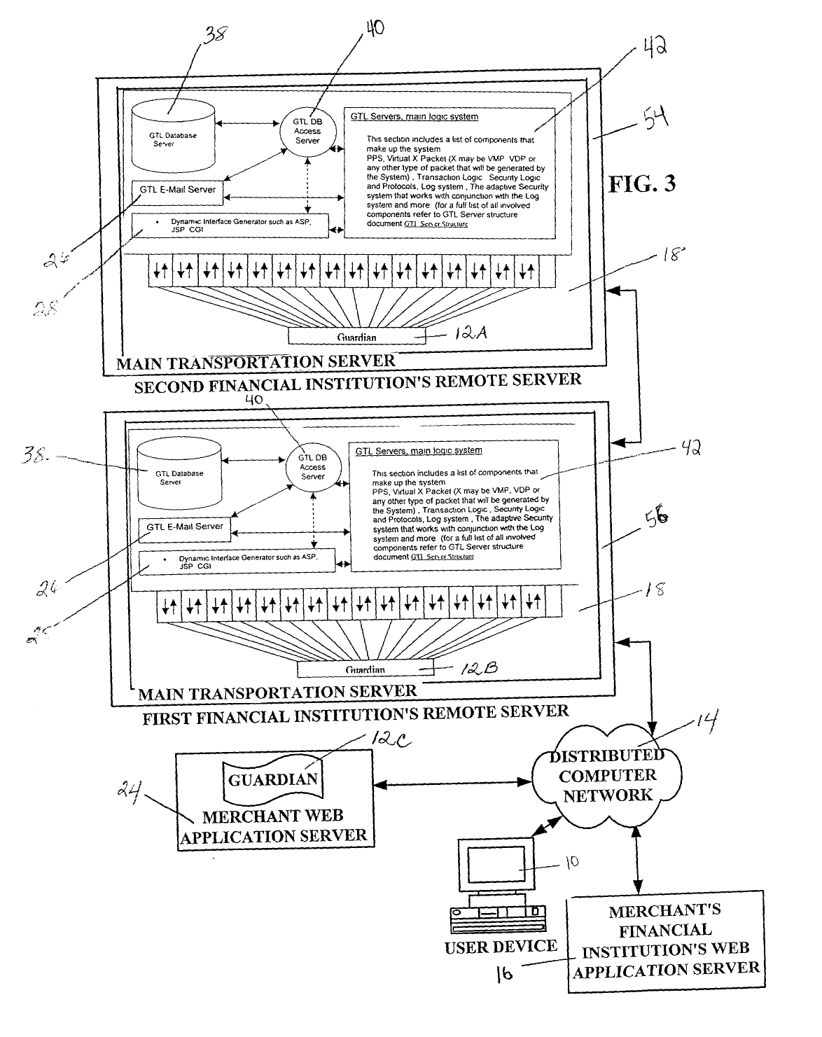

FIGS. 2 and 3 demonstrate alternative housing facilities for the main transportation server 18. FIG. 2 demonstrates how all or a portion of the functions of the main transportation server 18 can reside on the financial institution's remote server 22 as opposed to being independently situated as seen in FIG. 1. FIG. 3 demonstrates how all or a portion of the functions of the main transportation server 18 can reside on a number of financial institution's remote servers 22. As seen in FIG. 3, two financial institution's web application servers 22 house the functions of the main transportation server 18. While two financial institution's remote servers 22 are depicted in FIG. 3, it is understood that the invention is not limited to two financial institutions remote servers' 22 housing the functions of the main transportation server 18. A number of financial institution remote servers 22 can house this functionality. Also, a number of independent networks with separate main server can be operated on the Internet.

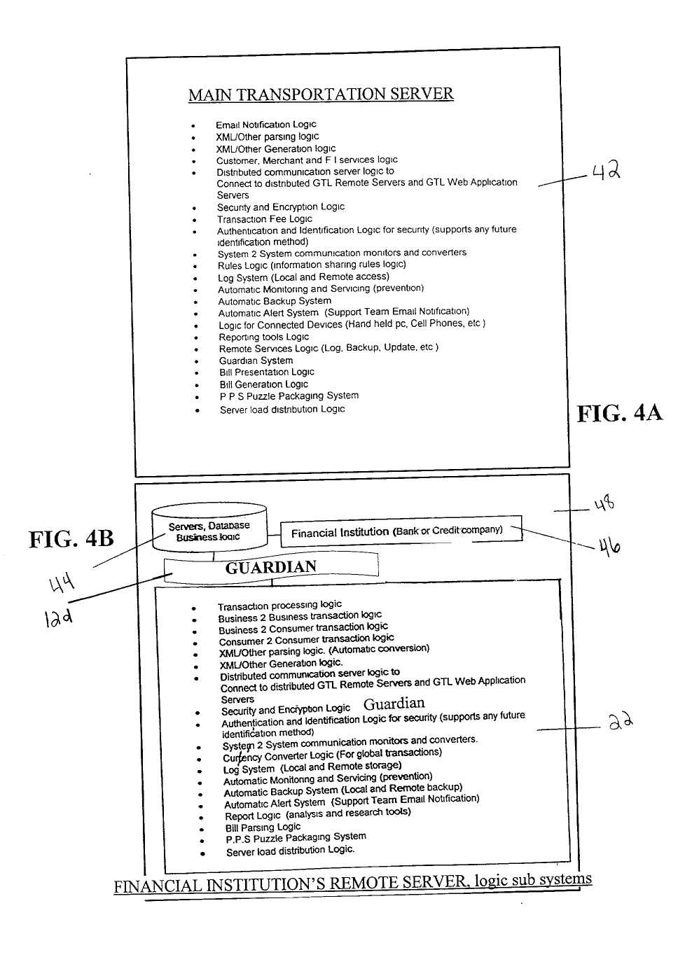

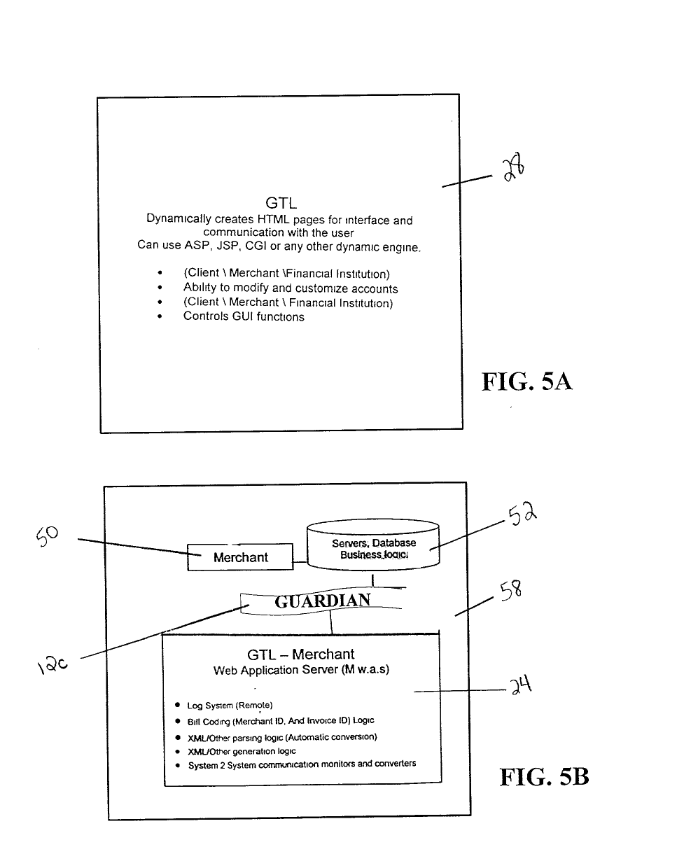

FIGS. 4a-5b depict specific components of the GTL system with more detail. FIG. 4a depicts the function features of the main transportation server 42 with more particularity. FIG. 4b depicts the hardware elements and functional features of the financial institution 48, both internal to the GTL system and external to the GTL system. The features external to the GTL system are the financial institution's database structures, namely the financial institution's business logic, 44 and the financial institution internal structure 46. The feature internal to the GTL system is the financial institution's remote server 22 depicted in FIGS. 1-2. As can be seen in FIG. 4b, the fmancial institution's web application server 22 comprises a number of listed components. FIG. 5a represents in more detail the components of the dynamic interface generator 28 of FIGS. 1-3, while FIG. 5b depicts the features of the merchant computer system 58 both internal to the GTL system and external to the GTL system. The merchant's internal structure 50 and the merchant's servers and database business logic 52 are external to the GTL system, while naturally the merchant's web application server 24 is internal to the GTL system. In FIG. 5b, the features of the merchant's web application server 24 are listed in more detail.

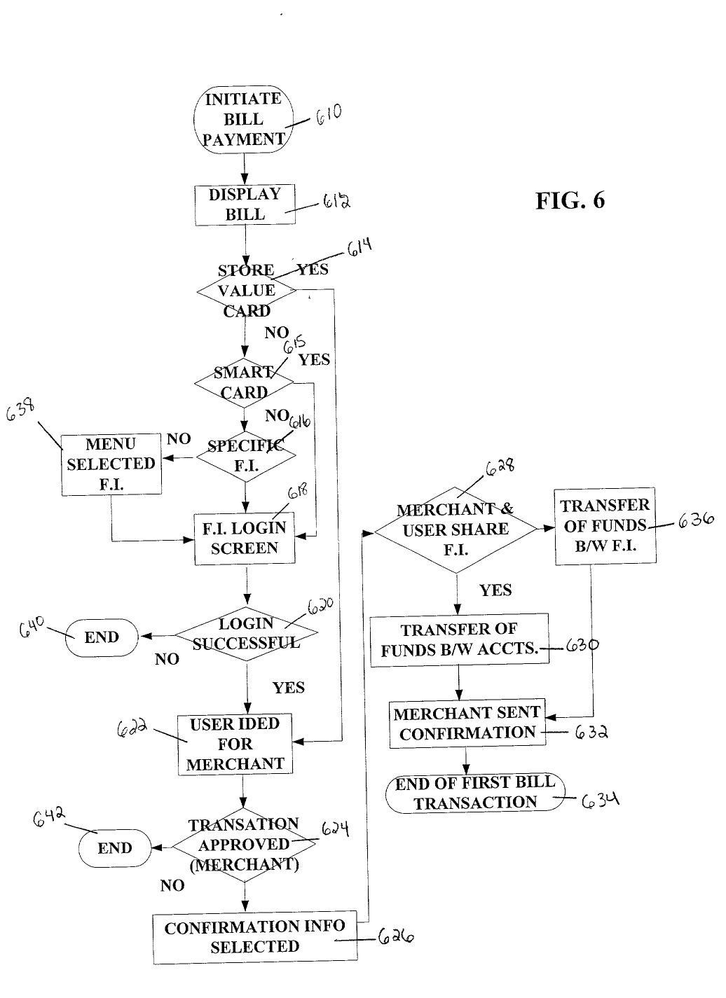

In FIG. 6, a flowchart is shown depicting a process for payment of a bill in accordance with an exemplary embodiment of the present invention. In the first step 610 in the bill payment process, the system displays the bill in step 612 to the user. Next, the system checks to see if the user has a store value card in step 614. A store value card is essentially a card with a credit balance, but without identifying information.

Should the user have a store value card in step 614, in step 622 the system automatically routes the user to the financial institution associated with the store value card and prompts the user for identification information to be sent to the merchant. A smart card is essentially a store card, but with identifying information. If the user does not have a store value card, the system then inquires in step 615 whether the user has a smart card. If the user does not have a smart card in step 615, the user is routed automatically to the login screen of the financial institution associated with that smart card. If the user does not have a smart card, the system then inquires in step 616 whether the user has an account with a specific financial institution. If a financial institution has been identified, the user is directed to its login screen in step 620. If the user has not designated a financial institution, the system lists a set of financial institutions associated with this particular invoice or bill in step 638. The user then selects a financial institution from a menu in step 638. Next the user logs onto the financial institution's system in step 616. If the log on is successful in step 620, the system prompts the user for identification to send to the merchant in step 622.

Once the user inputs identification information to be sent to the merchant in step 622, the merchant approves the transaction in step 624. If the transaction is approved in step 624, in step 626 the user selects the type of confirmation, which the user would like to receive. If the transaction is not approved the process ends at step 642.

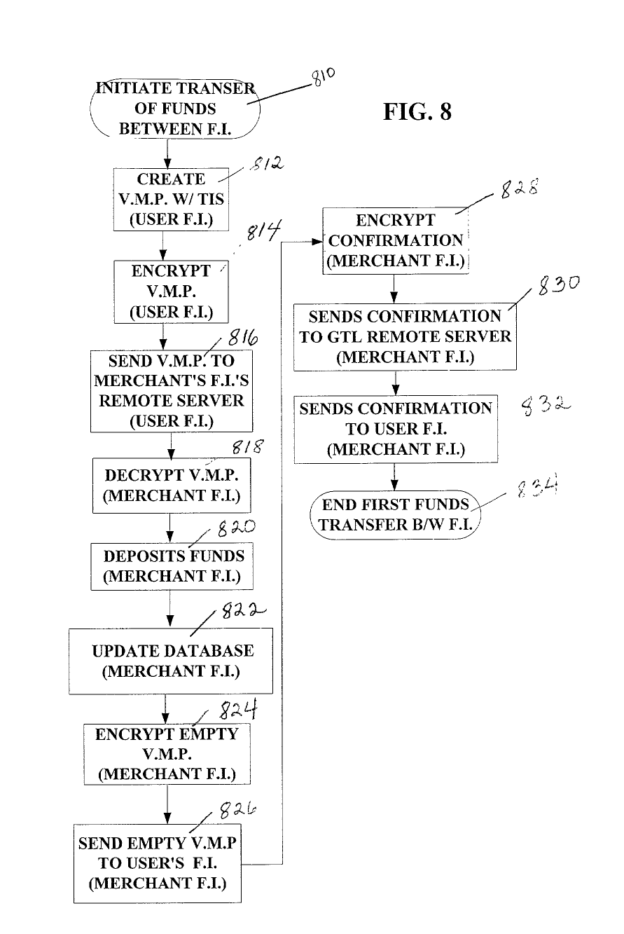

Next the system determines whether or not the merchant's financial institution's web application server 16 and the user's financial institution are the same in step 628. If the merchant's financial institution's web application server 16 and the user's financial institution are the same, the funds are transferred between accounts in step 630 and the merchant is sent a confirmation in 632. The process then ends in step 634. If the merchant's financial institution's web application server 16 and the user's financial institution differ, a different process occurs in step 1030 which will be discussed in detail with regard to FIG. 8, during which funds are transferred from the financial institution of the user to the financial institution of the merchant. However, whether or not the merchant and user share fmancial institutions does not effect the merchant confirmation. In either case, the merchant receives a confirmation in step 632 and the transaction ends in step 634.

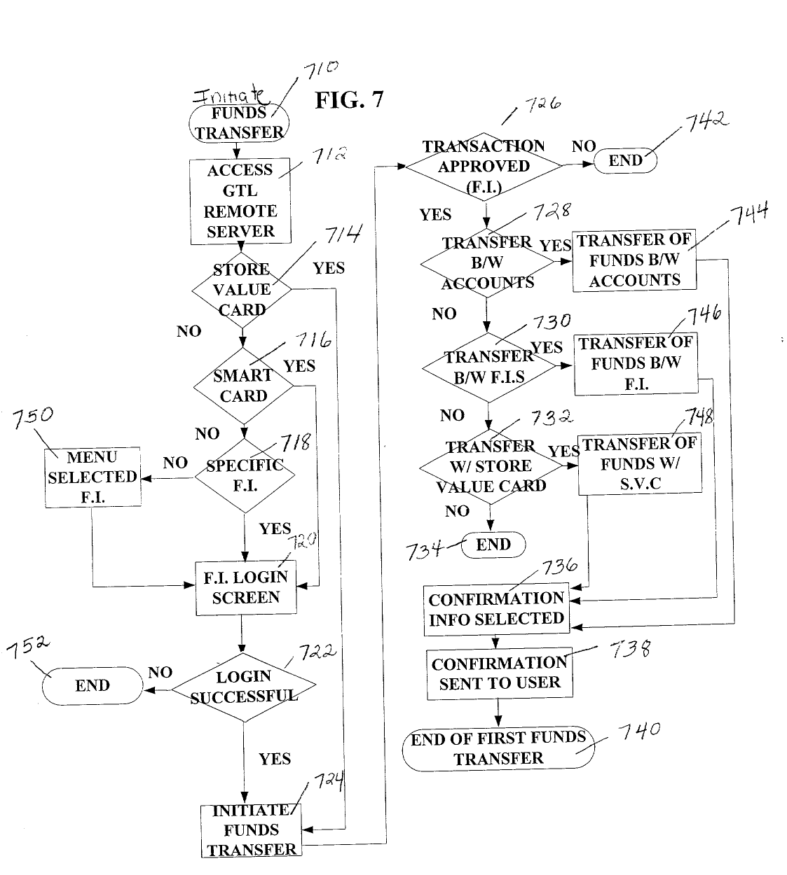

In FIG. 7, a flowchart is shown depicting a process for funds transfer in accordance with an exemplary embodiment of the present invention. Besides bill and invoice payment, the present invention also includes a funds transfer method initiated in step 710.

First the user accesses the main transportation server in step 712. Next a determination is made in step 714 of whether the user has a store value card. If so, the user automatically accesses the financial institution associated with that store value card and initiates the funds transfer in step 724. If the user does not have a store value card in step 714, the system prompts the user in step 716 to indicate whether he has a smart card. If the user has a smart card, the user is automatically directed to the login screen of the financial institution associated with that smart card. If the login is successful in step 722, the funds transfer is initiated in step724.

If the user has neither a store value card in step 714 nor a smart card in step 716, program determines in step 718 if the user has selected a specific fmancial institution. If so, the user is directed to the login screen of the institution in step 720. If not, the system lists a number of fmancial institutions in step 718. The user must then select a particular financial institution from the financial institution menu in step 750. Then the user is directed to the login screen of the financial institution selected in step 720.

A successful financial institution login in step 722 will initiate the funds transfer in step 724, while an unsuccessful one will end the transaction in step 752. If the transaction is not approved, the process will end in step 742. However, if the financial institution approves the transfer in step 726, the system determines whether or not the funds transfer will be between accounts in step 728 or between financial institutions in step 730 or between store value cards in step 732. In any case, whether the transfer is between accounts, financial institutions, or smart value cards, the user selects confirmation information in step 736 and a confirmation is sent in step738. The process then ends in step 740.

In FIG. 8, a flowchart depicting a process for funds transfer between financial institutions in accordance with an exemplary embodiment of the present invention is shown. When initiating a transfer of funds between financial institutions in step 810, as discussed earlier, a different process is followed.

First, the process is started in step 810. Then the system creates a virtual money packet in step 812. Then the user's financial institutions encrypts this virtual money packet in step 814. Once the virtual money packet has been encrypted, the user's financial institution sends the virtual money packet to the merchant financial institution's remote server in step 816.

At the merchant financial institution's remote server, the virtual money packet is decrypted in step 818. The funds are then deposited in the merchant financial institution's account in step 818. Next, the merchant's financial institution's database is updated in step 822 and an empty virtual money packet is encrypted in step 824 and sent to the user's financial institution in step 826. Then, the system sends an encrypted confirmation in step 828 to the merchant's financial institution. Finally, the system sends the user's financial institution a confirmation in step 832 before the first funds transfer ends in step 834.

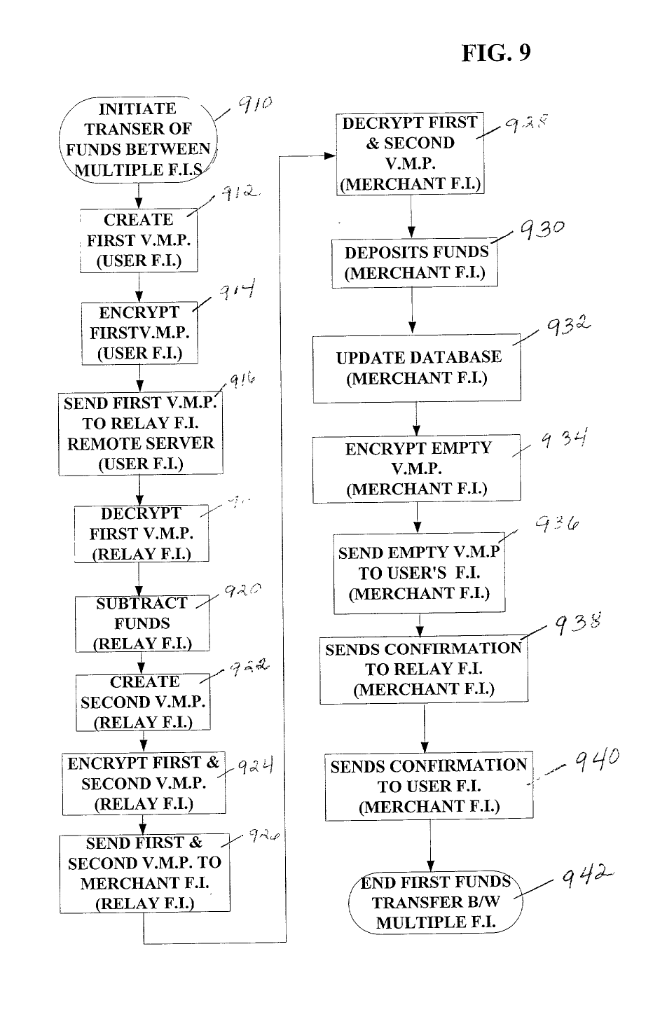

In FIG. 9, a flowchart depicting a process for funds transfer amongst multiple financial institutions in accordance with an exemplary embodiment of the present invention is shown. Funds transfer amongst multiple financial institutions involves relay financial institution servers.

The process is initiated in step 1310. Then, as with funds transfer between two financial institutions as depicted in FIG. 8, the system creates virtual money packets. Once the user's financial institution generates the first virtual money packet in step 912, the user's financial institution then encrypts the virtual money packet in step 914. Finally, the user's financial institution sends the first virtual money packet to a relay financial institution's remote server in step 916.

The first task of the relay financial institution's remote server is to decrypt the first virtual money packet in step 918. Once the relay financial institution decrypts the first virtual money packet in step 918, the relay financial institution subtracts the funds in step 920, creates a second virtual money packet in step 922 and sends the first and second virtual money packets to the merchant's financial institution in step 926.

Upon receiving the first and second virtual money packets, the merchant's financial institution decrypts the first and second virtual money packets in step 928. Next, the merchant's financial institution deposits the funds in step 930. Then the merchant's database is updated in step 932 and the empty VMP is encrypted in step 934. Next in step 936 the empty VMP is sent back to the user's fmancial institution. Finally, the merchant's financial institution sends confirmations to the relay financial institution in step 938 and the user's financial institution in step 940. In addition, the merchant's financial institution sends confirmations to the user's financial institution in step 936. The process ends at step 942.

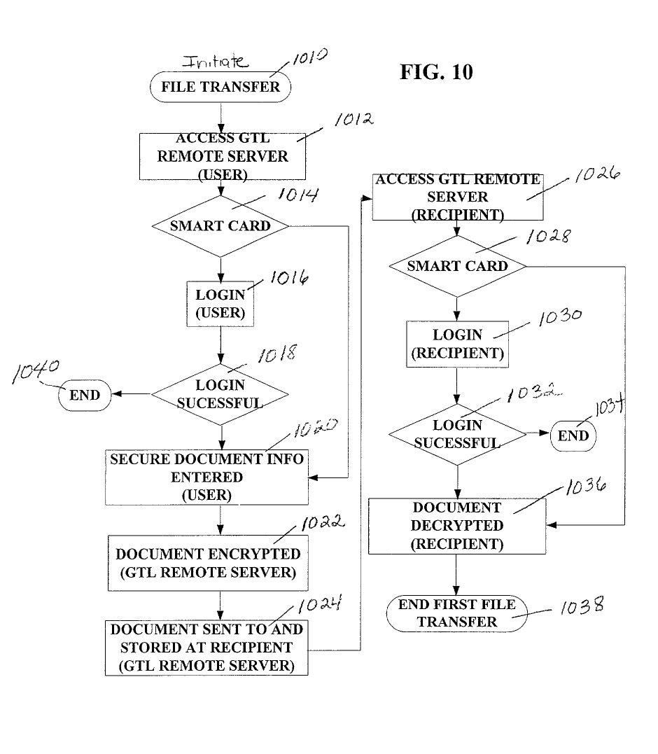

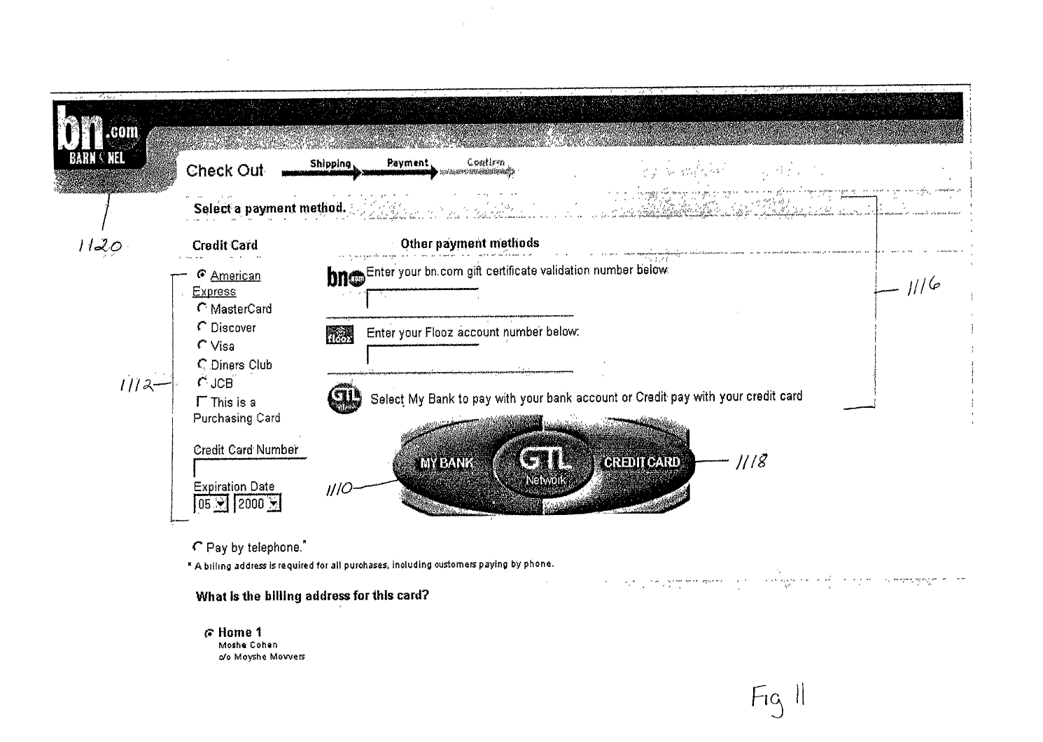

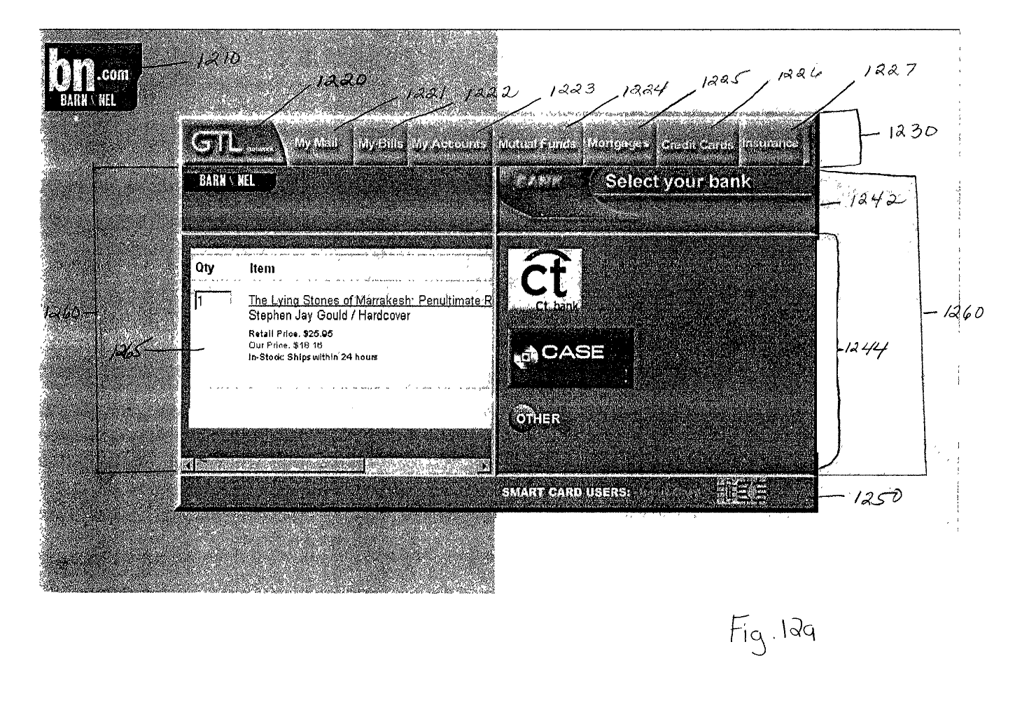

In FIG. 10, there is a flowchart depicting a process for encrypted file transfers in accordance with an exemplary embodiment of the present invention is shown. First, the user initiates the file transfer in step 1010. Next in step 1012 the user accesses the main transportation server. The system prompts the user for a smart card in step 1014. However, if the user does not have one, the user simply logs onto the system as the user normally would. Should the user have a smart card, the user automatically begins entering secure document information into the system 1020.

Assuming the user successfully logs onto the system in step1O18, the user then enters information about the secured document in step 1020. Such relevant information could include, but is not limited to the file name and the recipient's address. Next, the main transportation server encrypts the document in step 1O22 and sends the encrypted document to the intended recipient in step 1024.

To access the secured document, the recipient accesses the main transportation server in step 1026. As with the sending user, the main transportation server 18 prompts the recipient user for a smart card in step 1028. If the user has a smart card, the main transportation server 18 immediately decrypts the document in step 1036. If the recipient does not have a smart card, the recipient simply logs onto the system in step1O30. If the login is successful in step 1032, the main transportation server decrypts the document in step1O36 and the first file transfer ends at step 1038. If the login is not successful, the process ends at step 1034.

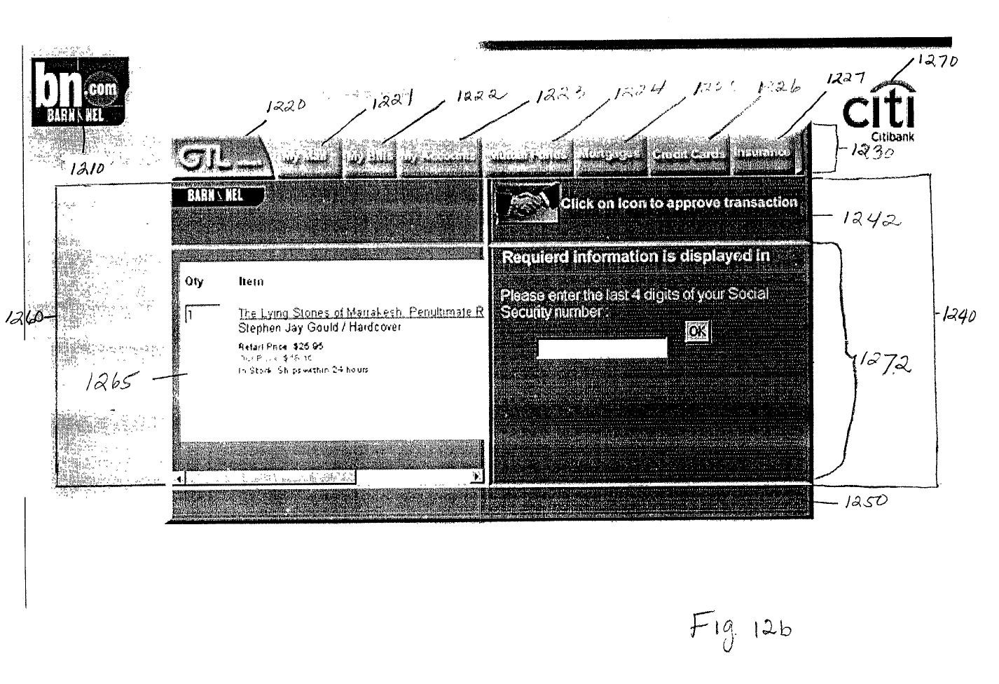

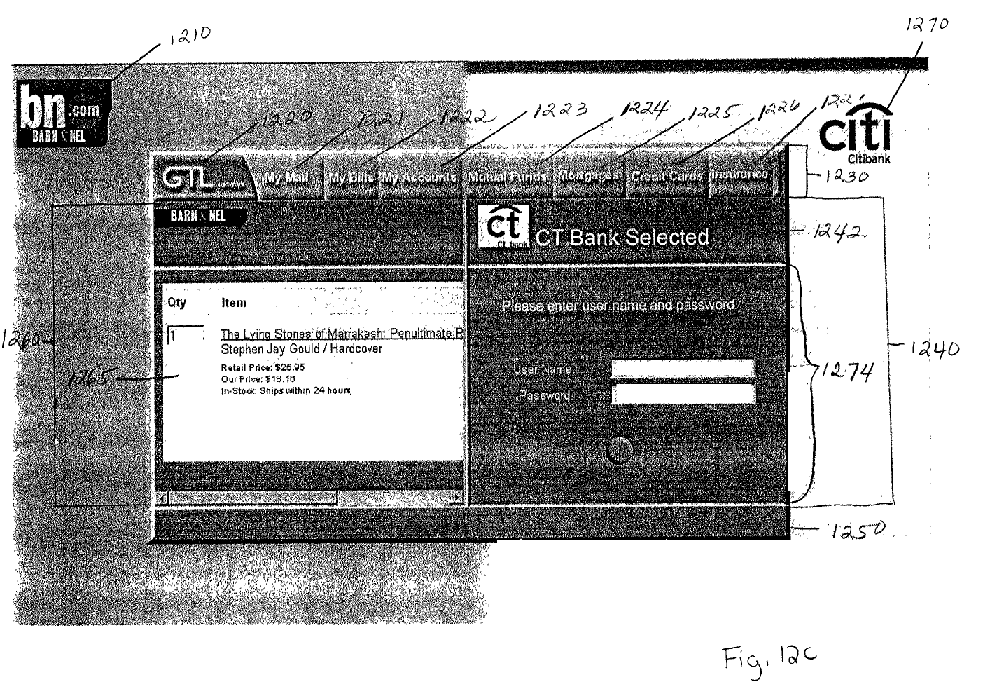

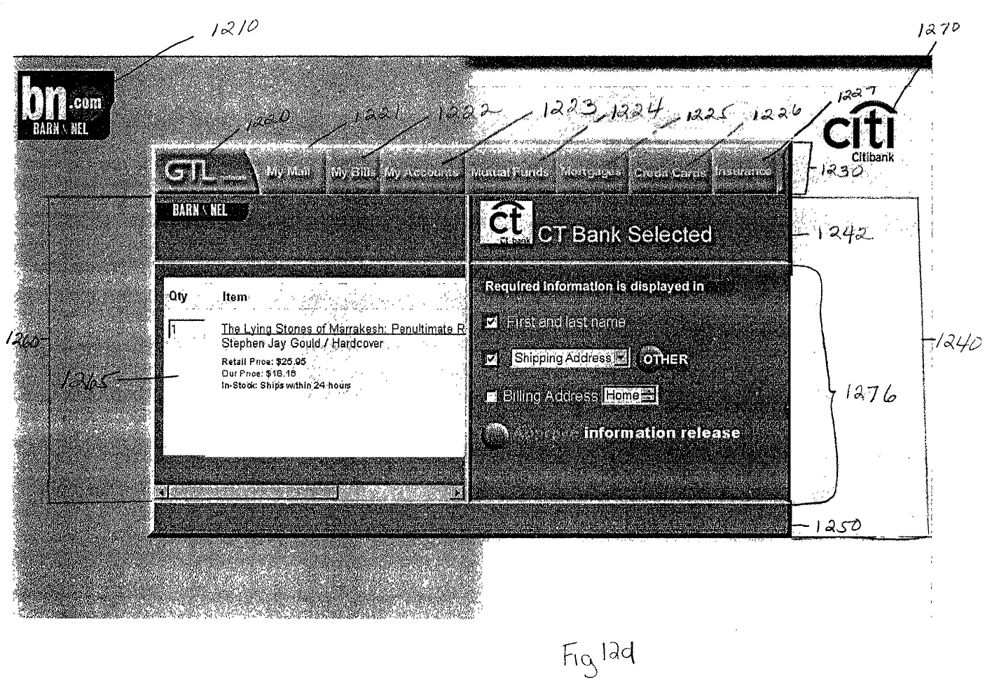

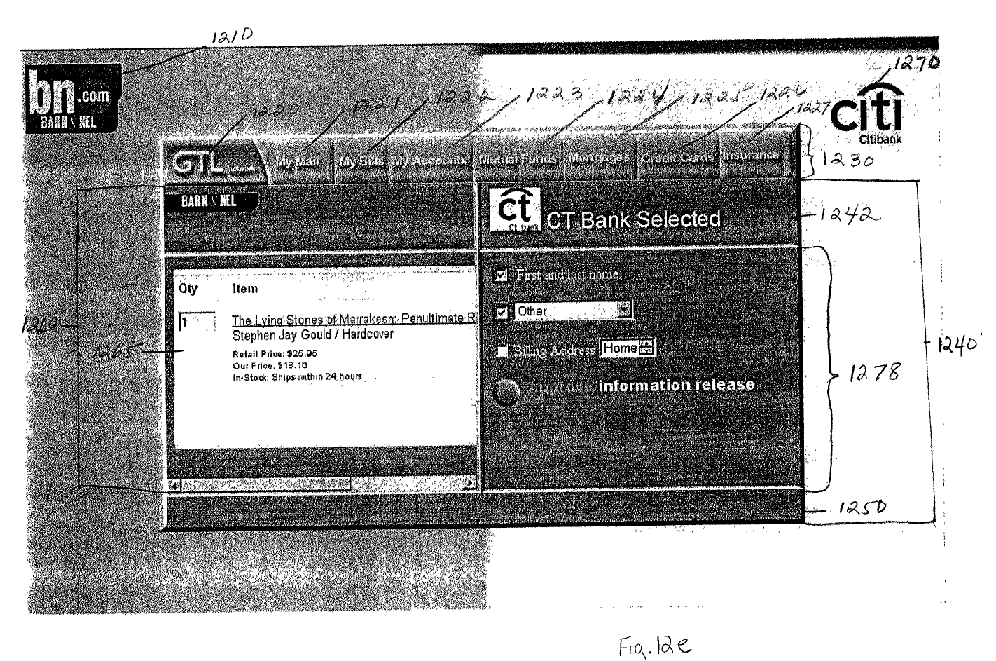

FIG. 11 is an exemplary purchase Web page illustrating the merchant's transportation interface or Web page 1120 in an embodiment of the present invention. When a user sitting at the user device 10 entered the merchant's web application server 24, the user is presented with the Web page of FIG. 11. Depending on the user's responses to the selectable options on the Web page, the user will be transported to another transportation interface. In FIG. 11, the user has indicated that the user would like to make a purchase. In response, the system presents a number of payment options to the user. The user can select a credit card payment option 1118. As seen in FIG. 11, a number of various credit card companies are selectable by the user. Some of the credit card payment options 1112 are hypertext links whereas other require the user to select a check off box. The invention is not limited to either of these two selection techniques. The system also presents alternative payment methods 1116. As seen in FIG. 11, the user can pay using a gift certificate, a Flooz account or by entering the GTL system. If the user chooses to enter the GTL system, the user selects either the “My Bank” option 1110 or the “Credit Card” option 1118. If the user selects “My Bank” option 1110, the system will present new Web page interfaces to the user as seen in FIG. 12a. If the user selects the “Credit Card” option 1118, the user is routed to FIG. 13a.

FIG. 12a is a Web page which is maintained by the main transportation server 18. This Web page has several portions. In particular, there is a merchant portion 1210 which contains the logo of the merchant from whose Web site the user was directed. A participating merchant can design this portion for its customers who are directed from the merchant's site to the Web page of the host server.

Another portion of the Web site is the GTL banner or task bar 1230. The GTL task bar 1230 maintains a number of tasks which the user can access upon completing a transaction. Besides the GTL logo 1220, the GTL task bar 1230 also contains the following user accessible tasks: My Mail 1221, My Bills 1221, My Accounts 1223, Mutual Funds 1224, Mortgages 1225, Credit Cards 1226, and Insurance 1227. These tasks while provided by the GTL system are not maintained by the GTL system. A particular merchant or fmancial institution could, for example, maintain the tasks. A financial institution could use the My Mail 1221 to send confirmation e-mails or other communications to the user. In addition, a merchant could maintain the My Bills 1222 as a central place for a user to get their account status. The task bar 1230 can be customized for individual users and businesses or it can be a universal banner setup.

If the task bar 1230 is personalized as is demonstrated in FIG. 12a, the options available are personal to the individual user accessing the system. Task bars which are customized for businesses would include options which are industry specific. For example, a task bar for electronics businesses might include various electronic devices, such as “Computers” and “Hi-Fi Systems.”

A portion of the Web page of FIG. 12a is a transport link interface between the main transportation server and the merchant 1260. In this interface, there is a display of the merchant's logo and the merchant's invoice 1265.

A data transport interface between the main transportation server and participating financial institutions 1260 is shown in FIG. 12a . At the top of this portion, there is an instruction set 1242 which directs the user as to the operation of the interface 1260. In the major portion of the data transport interface 1244, the user is initially presented with a list of participating financial institutions. The instruction set 1242 directs the user to select one of the financial institutions, where he has an account.

Portion 1250 directs the user to smart card use. The GTL system includes smart card capabilities. If a user had a smart card, upon sliding the smart card through a reader at the user device 10, the user would directly access their own associated smart card accounts. While a slide reader has been mentioned, other means of smart card recognition can be used. Another use could be a smart card reading wand. The invention is not limited to these two forms of smart card identification. The invention also contemplates voice activation and cell phones as a means of identification.

The information entered by the user is not stored at the main transportation server. Server 18 merely provides a link and user interface to the user's own financial institution. Thus, no additional information is being supplied to the merchant or the system. All the information is being sent to the financial institution; the financial institution alone stores the information. Thus, the exposure of users to potential harm over the distributed computer network is substantially reduced or virtually eliminated.

After the user selects a financial institution, the user receives a third transportation interface in the window on the right side of the screen. This third interface is the banking institution's Web page 1240 as seen in FIG. 12b. Note that the invoice 1265 is still displayed in a window or portion on the left side of the screen in the merchant's transportation interface 1260 and that the task bar 1230 is still displayed. At this point the user, logs onto the banking institution 1272.

Once the user logs onto the banking institution 1272, the system transports the user to the Web page shown in FIG. 12c where the user is provided a secondary security measure. All three transportation interfaces are again depicted in the windows of FIG. 12c. In the banking institution's transportation interface 1240, the user enters a user name and password and then the system brings the user to the Web page of FIG. 12d.

FIG. 12d shows an exemplary merchant confirmation selection Web page in the right window. Here the user tells the banking institution what information from the fmancial institution's database the user would like released to the merchant for confirmation. Here the merchant confirmation information 1276 includes a name, a shipping address and a billing address. As seen in FIG. 12d, the user selected sending the merchant their name and shipping address.

FIG. 12e is a further merchant confirmation Web page accessed from FIG. 12d. Here, the user has elected to send an address “other” than the billing address in the merchant confirmation information box 1278. Besides confirmation purposes, “other” address also acts as a secondary identification source. Once the user selects this option, the user is sent to the Web page of FIG. 12f.

In FIG. 12f, the user is presented with an additional security measure. Here the user enters the user's mother's maiden name 1280 in order to ensure that the person entering the “other” address information is the authorized person to do so. Once the user enters the user's mother's maiden name, the user is sent to the Web page of FIG. 12g.

In FIG. 12g, the user must enter the “other” address information 1252. FIG. 12g is an exemplary user entered ID confirmation Web page accessed from FIG. 12f. After the user enters the “other” address information, the user is directed to select an account in the Web page shown in FIG. 12h.

In FIG. 12h, three accounts are displayed in the window 1290. The system section 1242 of the Web page directs the user to select one of the three accounts. This account selection Web page features a hover function. A user simply by placing the user's cursor over the account box views the account balance remaining in that account. Upon selecting an account 1290, the transaction is authorized by the banking institution which is shown in FIG. 12i.

In FIG. 12i, the PPS system is represented by the checked area splitting the screen and separating the banking institution's logo 1210 and the merchant's logo 1270. The system indicates that the transaction is being authorized in the window 1292.

Lastly, the user is told that the transaction was approved. FIG. 12j is an exemplary transaction approval Web page. As seen in the transaction confirmation 1268, the system assures the user that the fund transfers from the financial institution to the merchant has occurred. On the merchant portion Web page 1210, a transaction summary 1265 is provided.

As discussed above, FIG. 13a is an exemplary credit card institution selection Web page accessed from FIG. 11. Here, the main transportation server 18 system presents the user with a list of selectable credit card companies 1296 in the right window. As was previously shown in FIG. 12a, two transportation interfaces are presented in FIG. 13a. The first is the merchant transportation interface in the window or portion on the left 1260 which presents the invoice 1265 to the user. The second is the main transportation server 18 transportation interface in the window on the right. The familiar task bar 1230 is superimposed on both windows. In window 1296 an indication of a number of participating credit card companies with which the user can pay the invoice is provided. The list of credit card institutions 1296 includes, but is not limited to three credit card companies.

Once the user selects their credit card institution of choice in window 1296 of FIG. 13a, the system presents the user with a third transportation interface: the credit card institution transportation interface or Web pagel240 in FIG. 13b. As before, the user must log on to the credit card institution's system 1298. After logging on, the system sends the user to the Web page of FIG. 13c. While FIG. 13b depicts the user name and password as the identification source, other means of identification could be used. Upon logging in on the screen 1298, the user must once again set up the confirmation memo which the system sends the merchant.

FIGS. 13d-13e memorialize the confirmation memo setup for credit card institutions. The process matches fairly closely the confirmation memo setup procedure for banking institutions as depicted in FIGS. 12d-12g. As before the user selected sending the merchants name and shipping address from screen 1312 in FIG. 13d. Then, the user decided to provide a secondary address in the screen 1312 in FIG. 132. Lastly, the user manually entered the secondary address in the screen 1314 shown in FIG. 13e.

FIG. 13f is an exemplary transaction authorization Web page similar to the Web page shown in FIG. 12i. As before in FIG. 12i, the PPS system is represented by the black and white checks splitting the screen shown in FIG. 13f.

FIG. 13g is an exemplary transaction approval Web page. Note that the user is sent a transaction summary 1265 on the merchant's transportation interface frame 1260 and is sent a visual display on the credit card institution's transportation interface frame 1318 indicating that the transaction went through.

FIG. 14a represents the identification process using an associated account smart card instead of the traditional log in screen seen in FIGS. 12b and 13b. Note that in the widow 1320 the user is forewarned that the smart card is being identified. Once the smart card has been identified, the user is presented with the Web page as seen in FIG. 14b.

FIG. 14b provides an additional security measure in the window 1322 where the user logs in to the system. Once the system identifies the smart card and the user begins the confirmation memo setup process as seen before.

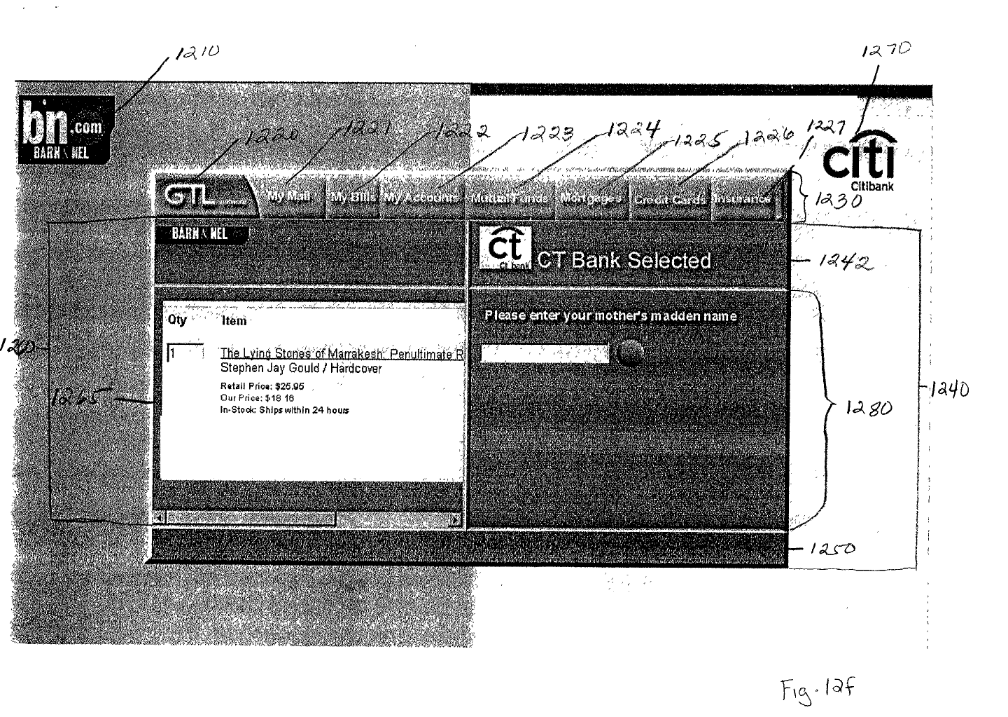

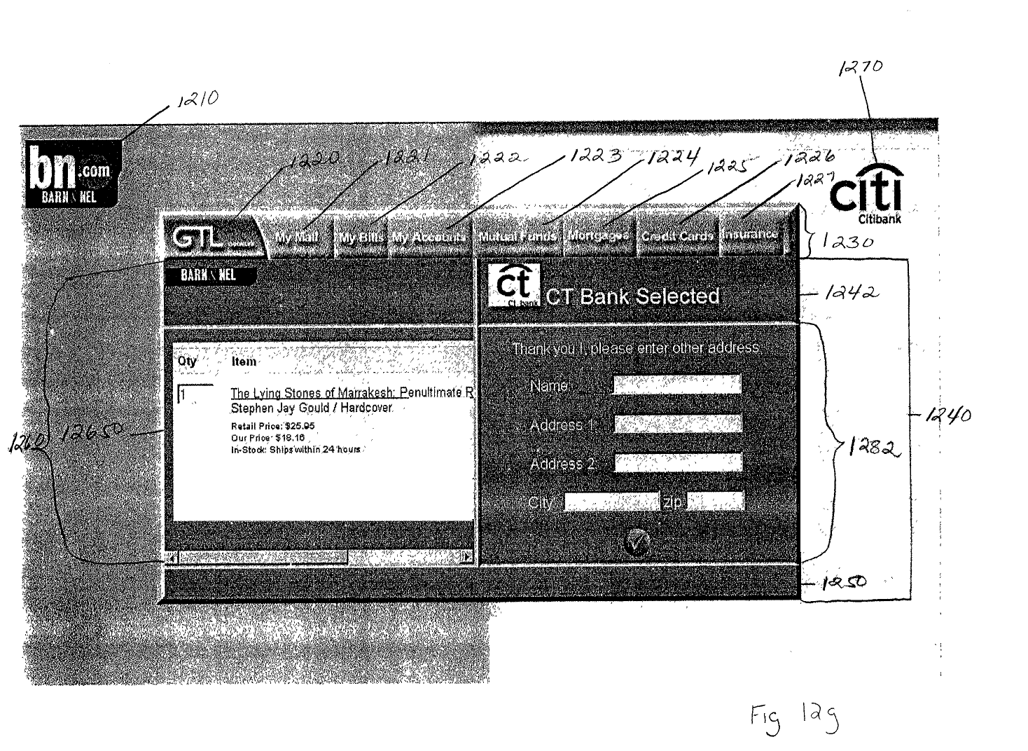

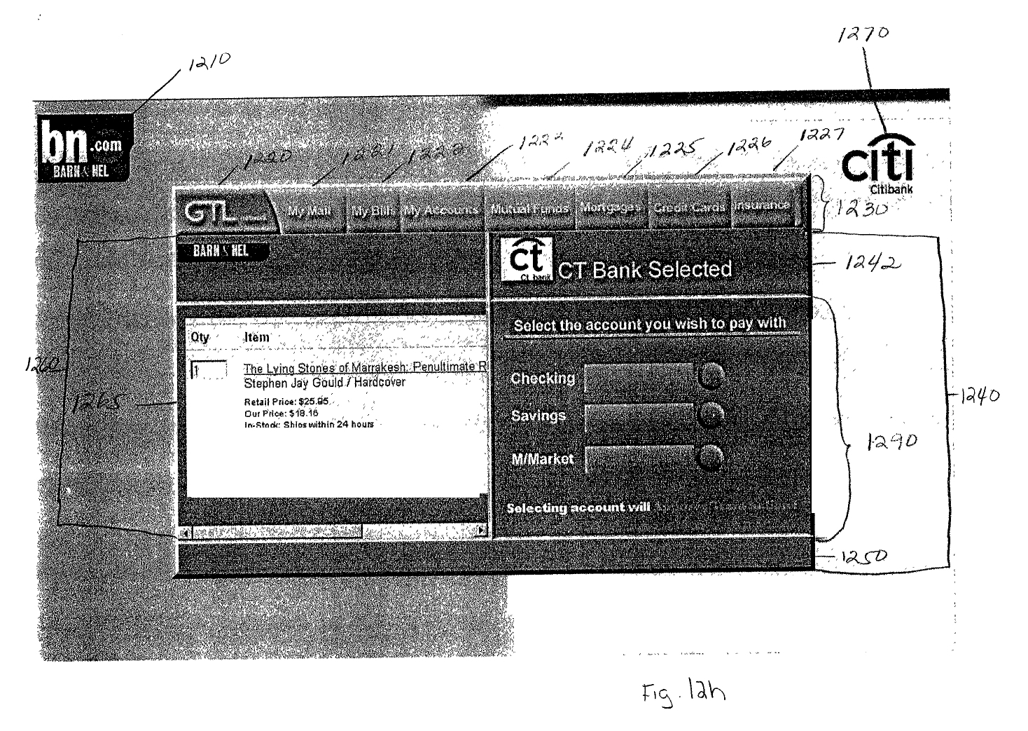

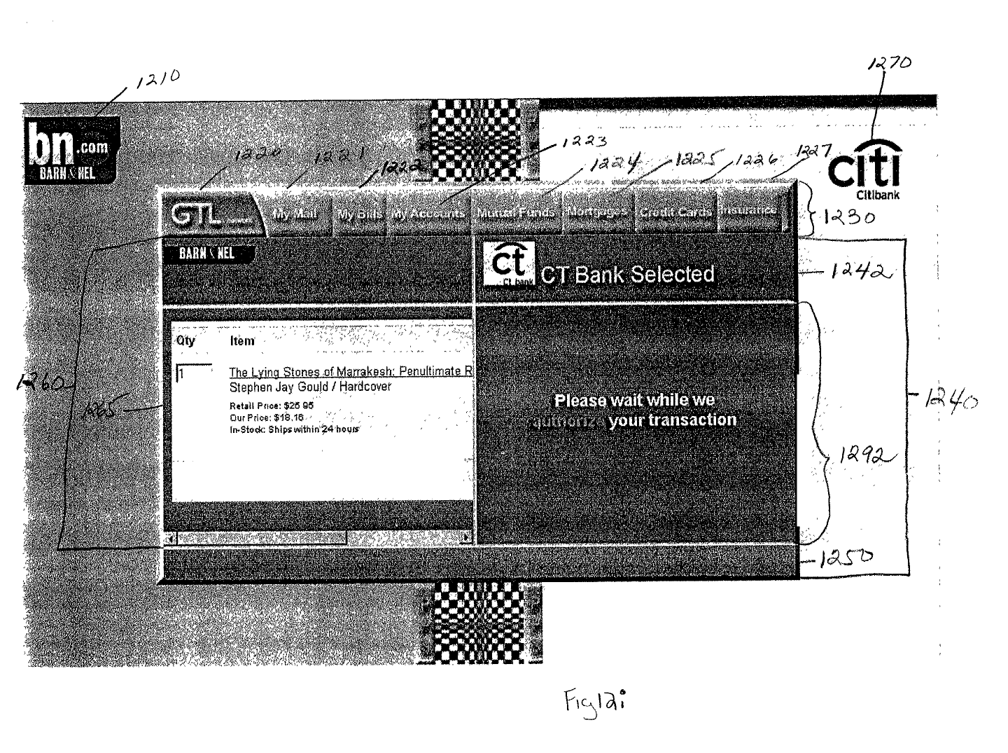

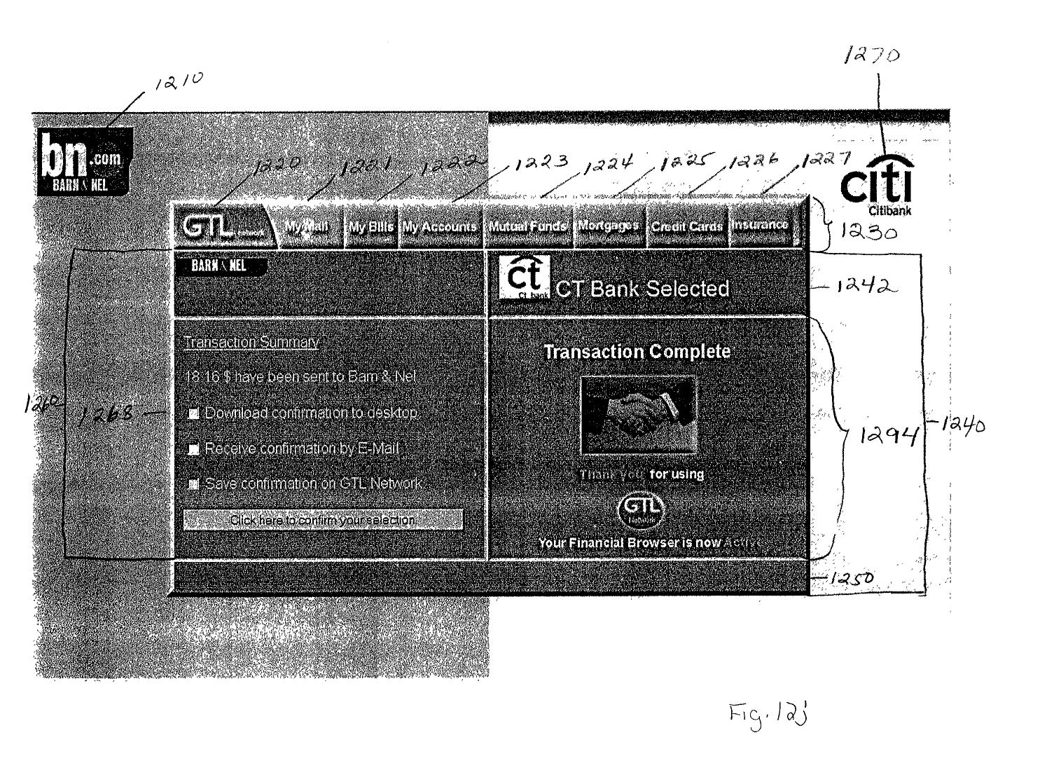

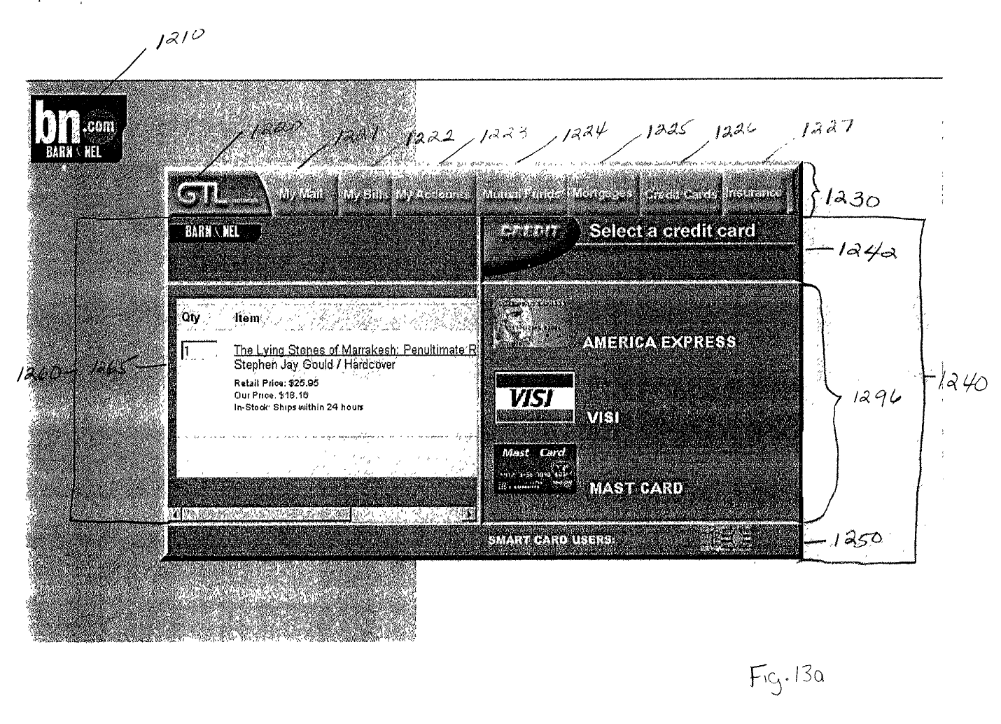

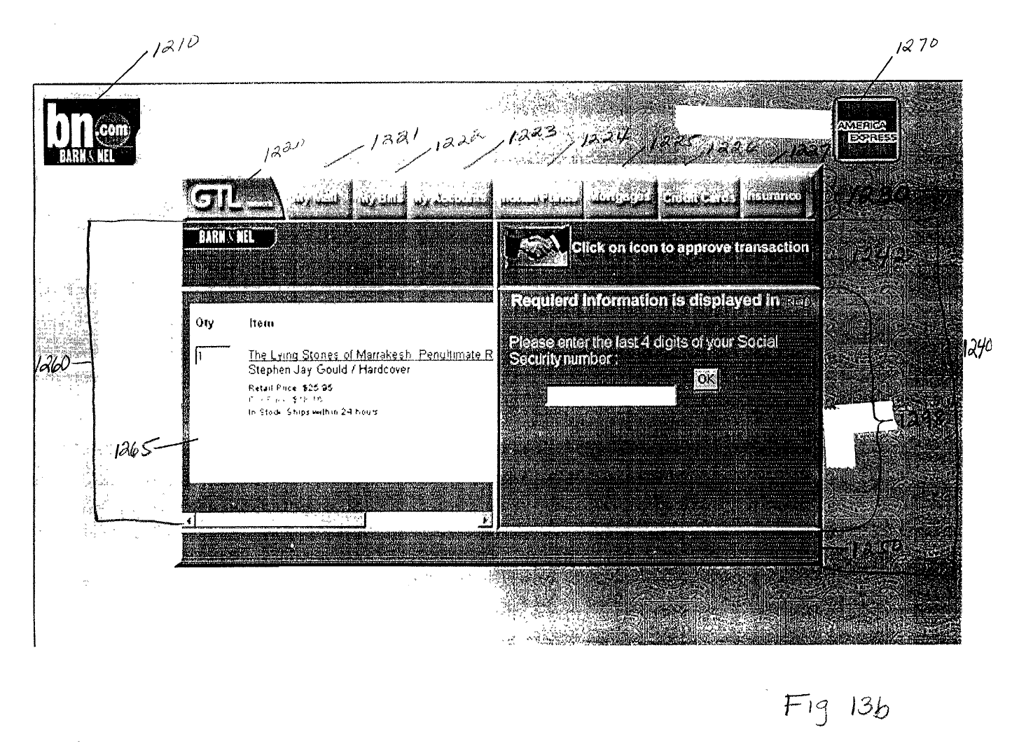

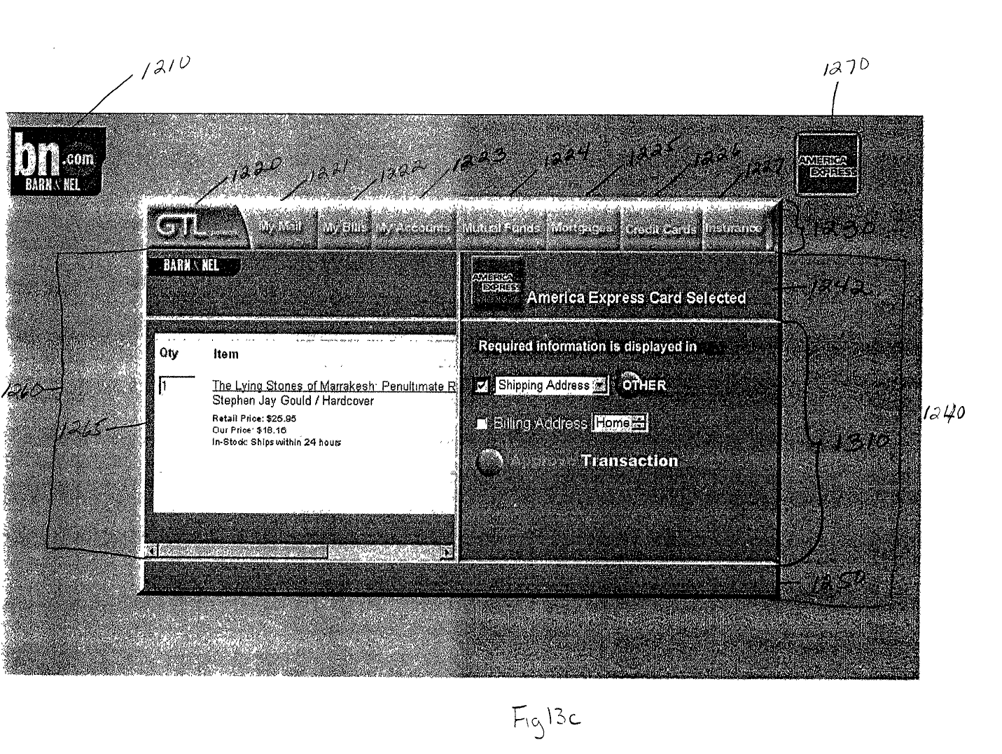

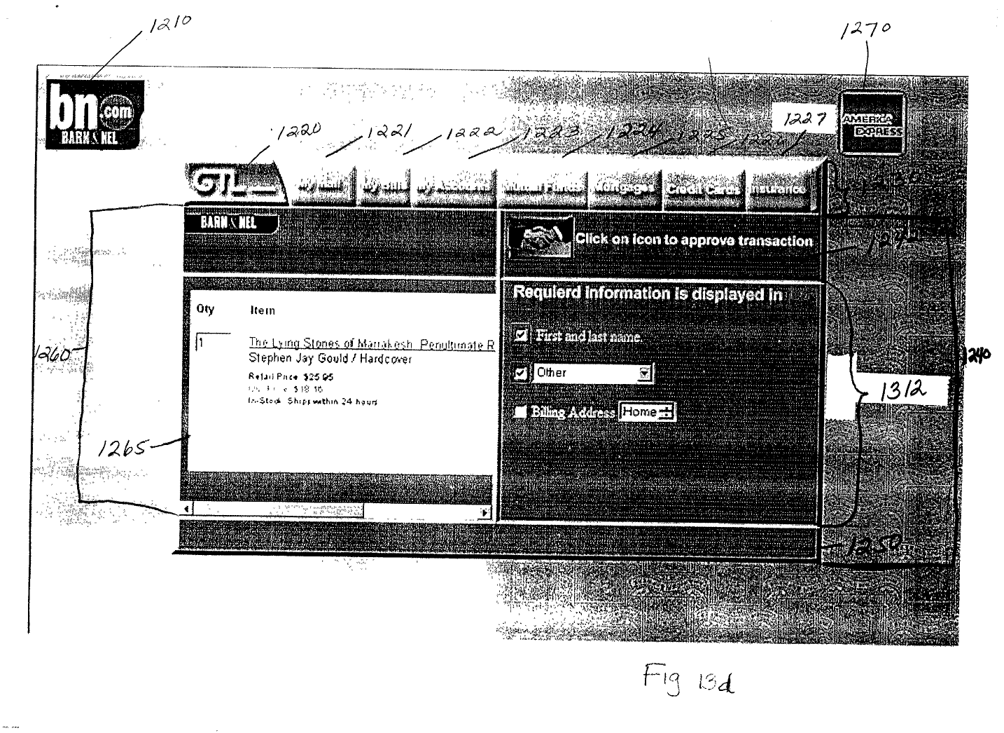

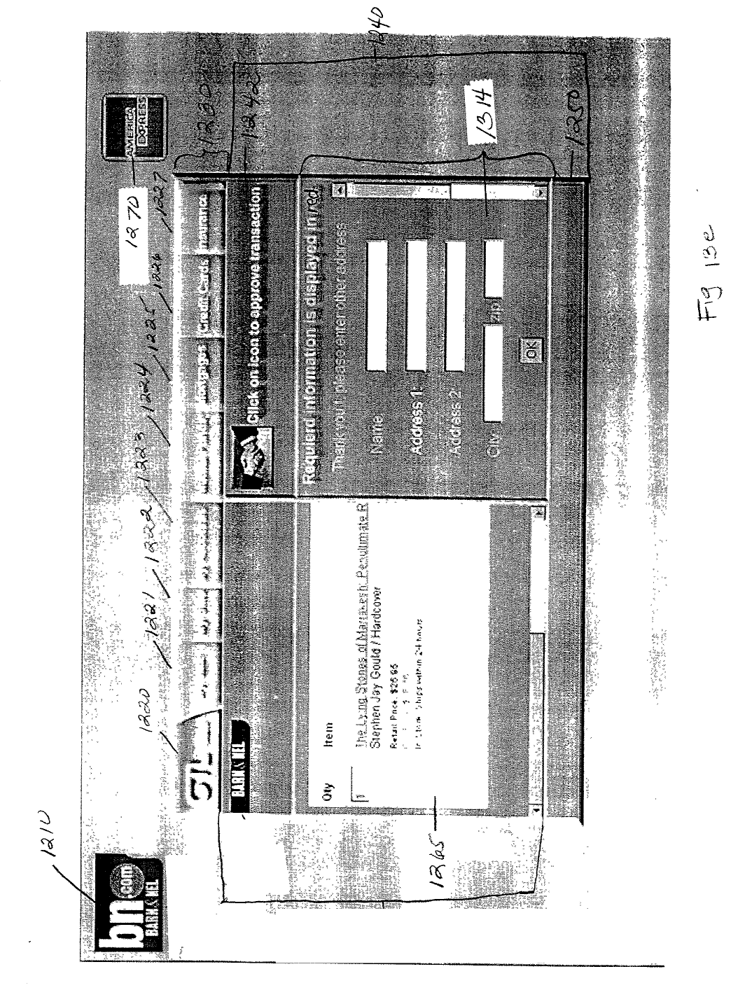

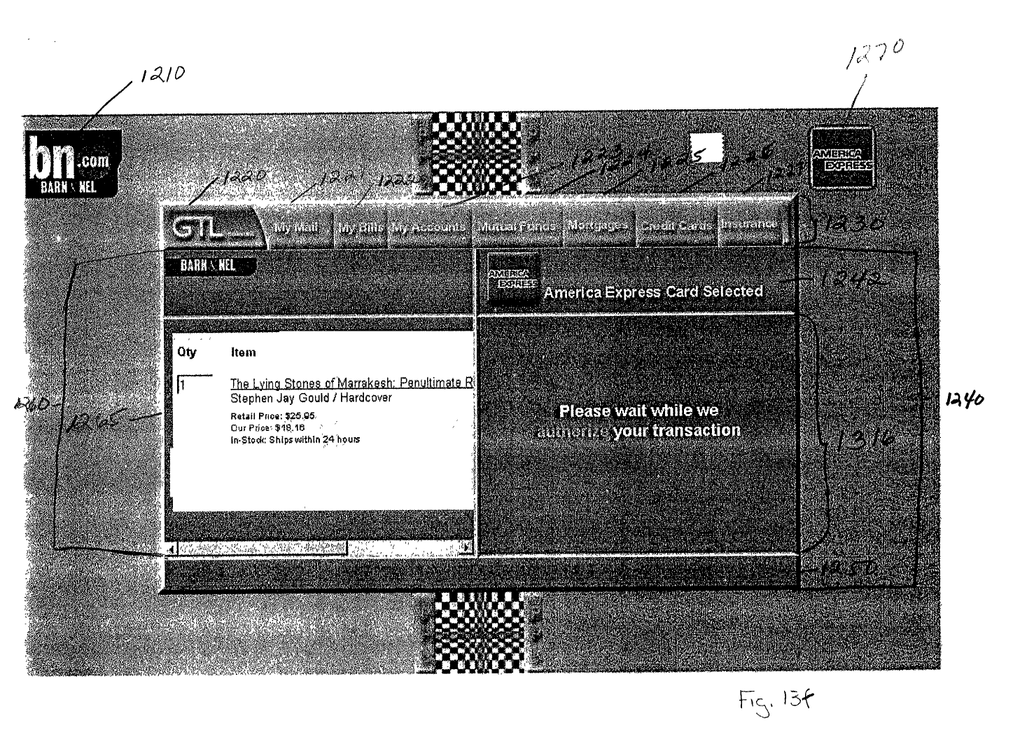

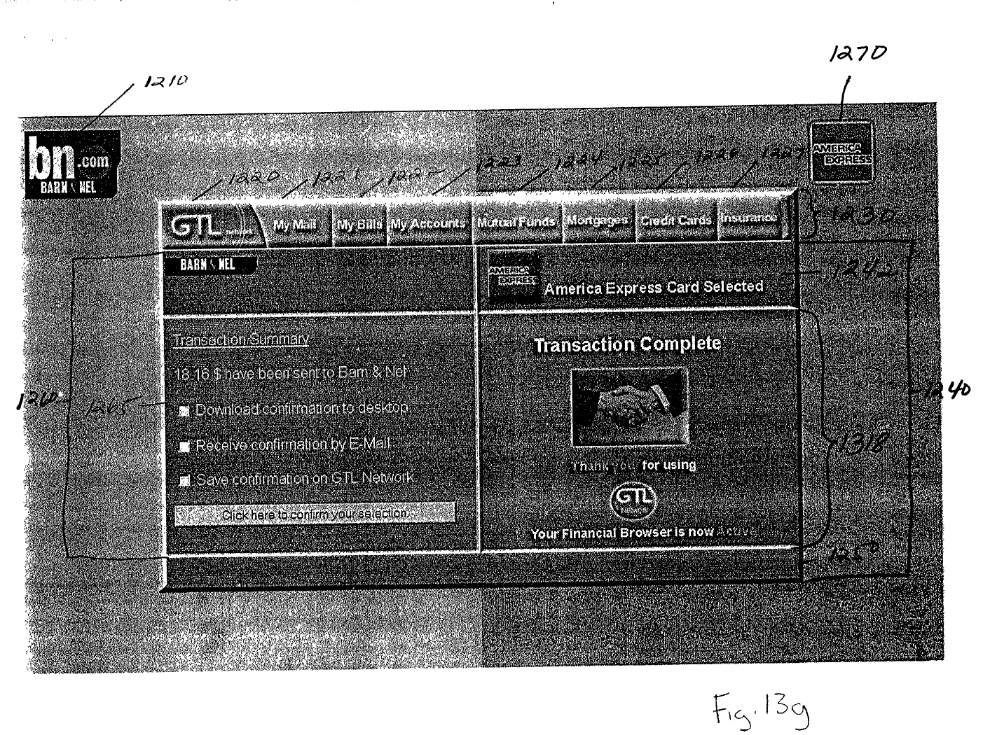

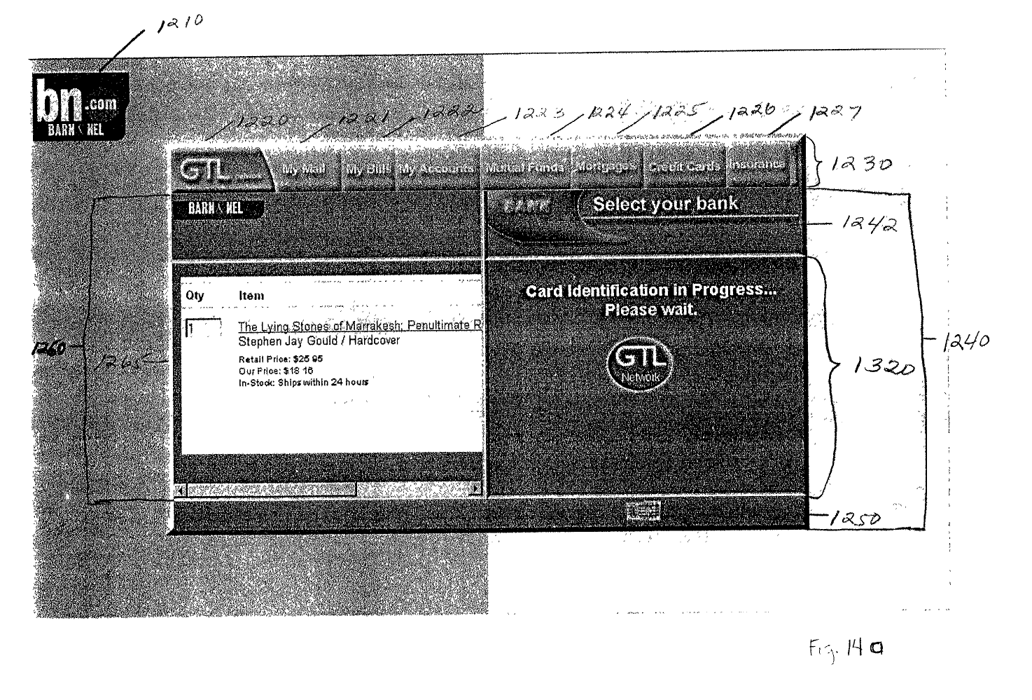

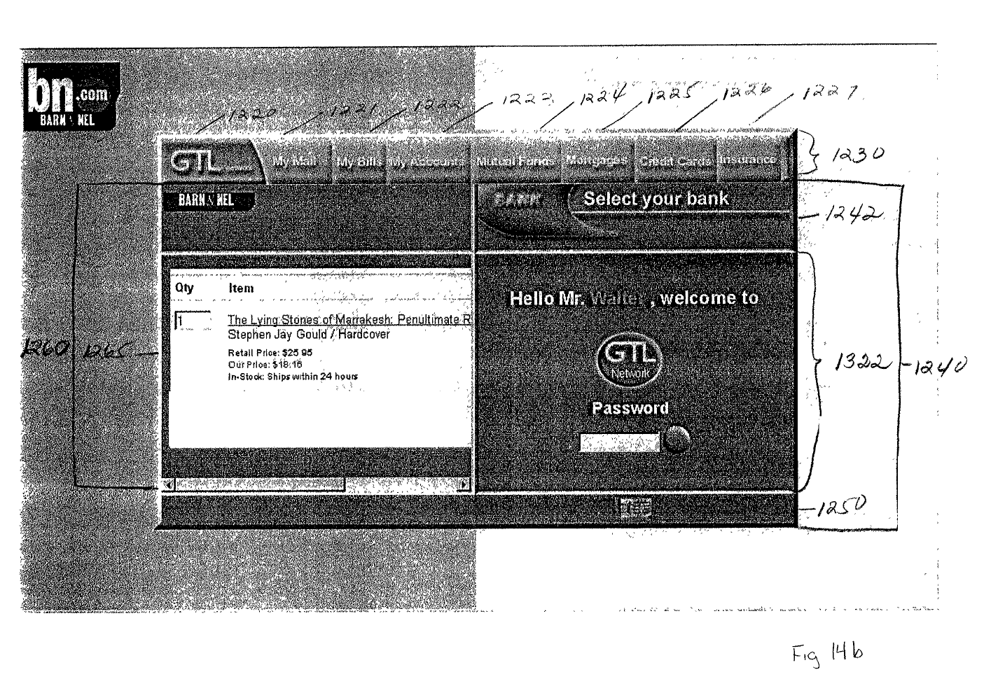

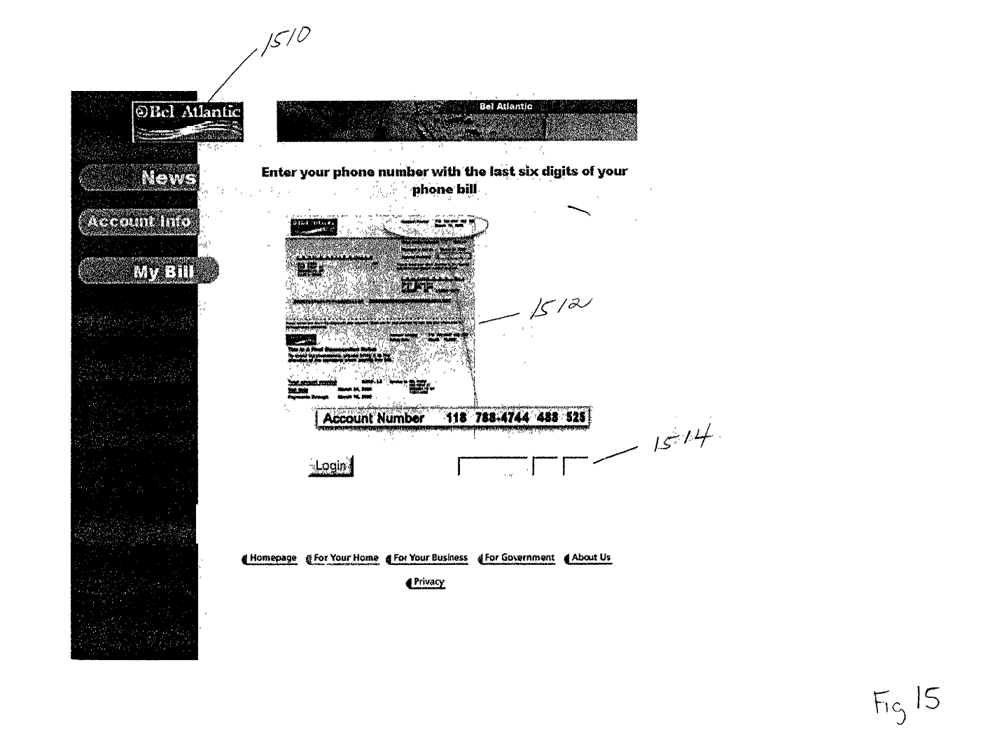

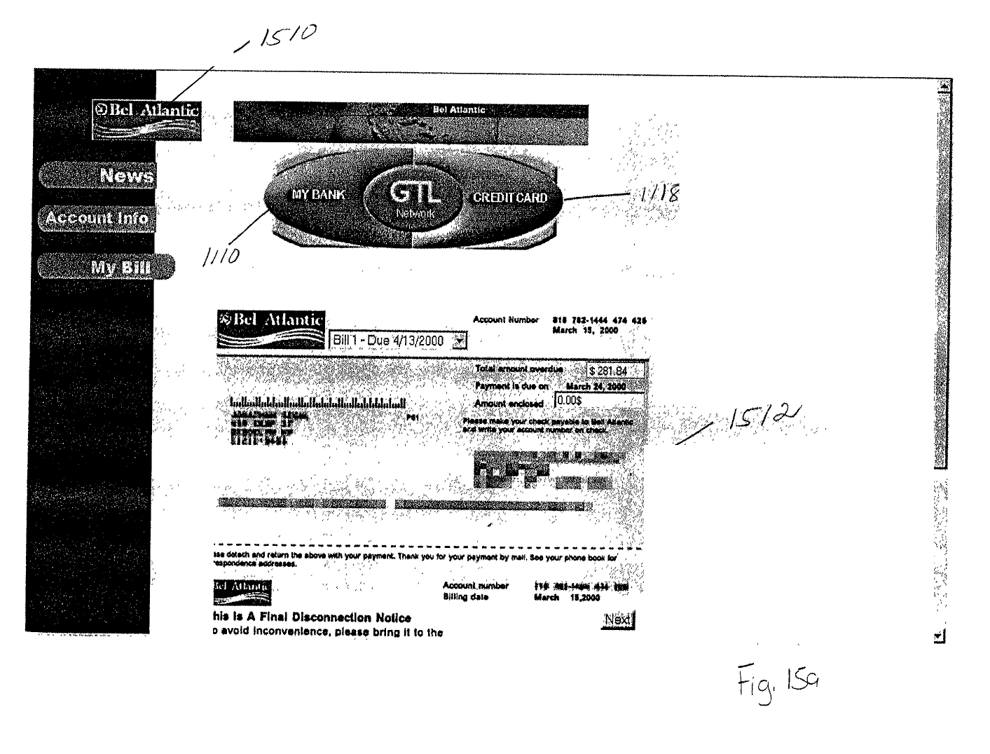

With reference now to FIG. 15, there is presented an exemplary bill presentment Web page in accordance with an exemplary embodiment of the present invention. As before, this Web page is accessed from the merchant's own Web site. Note that the system displays the bill collector's transportation interface 1510 which is also customizable. In addition, the system presents the bill 1512 to the user and an opportunity to log on to the system 1514, for example by entering a password in the space . Once the user logs onto the system in FIG. 15, the system sends the user to FIG. 15a.

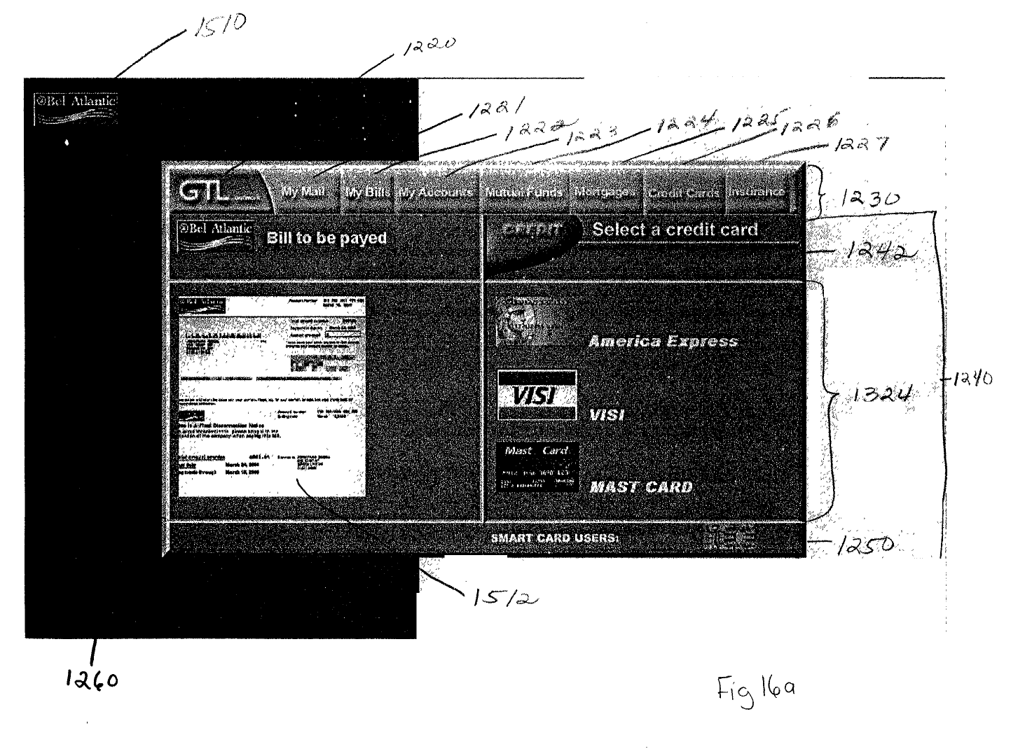

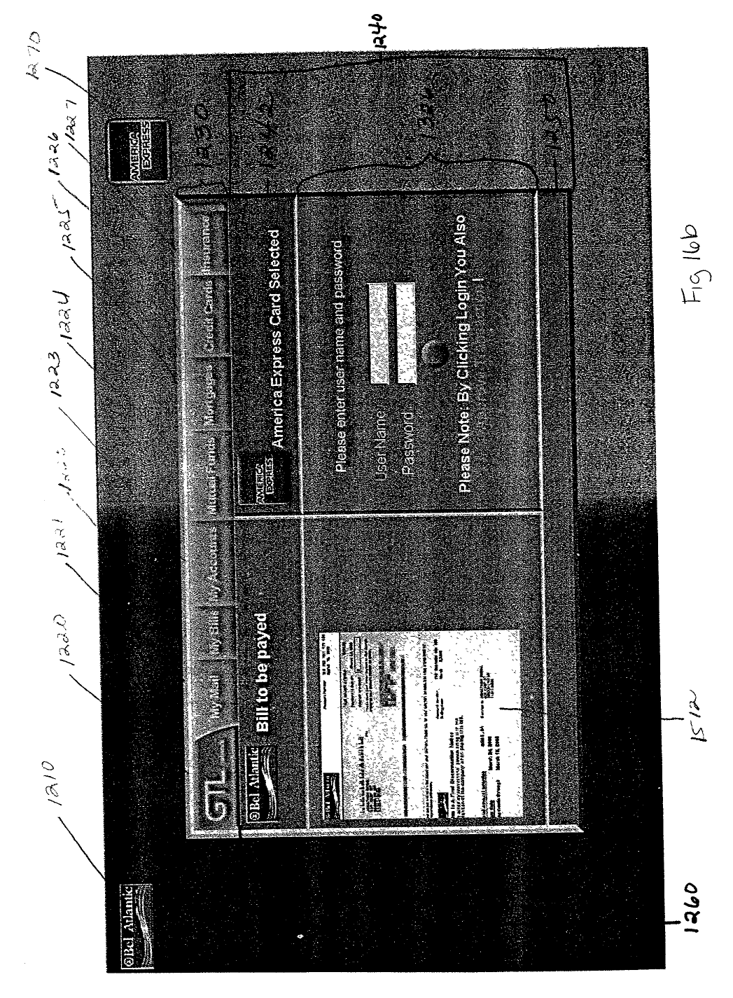

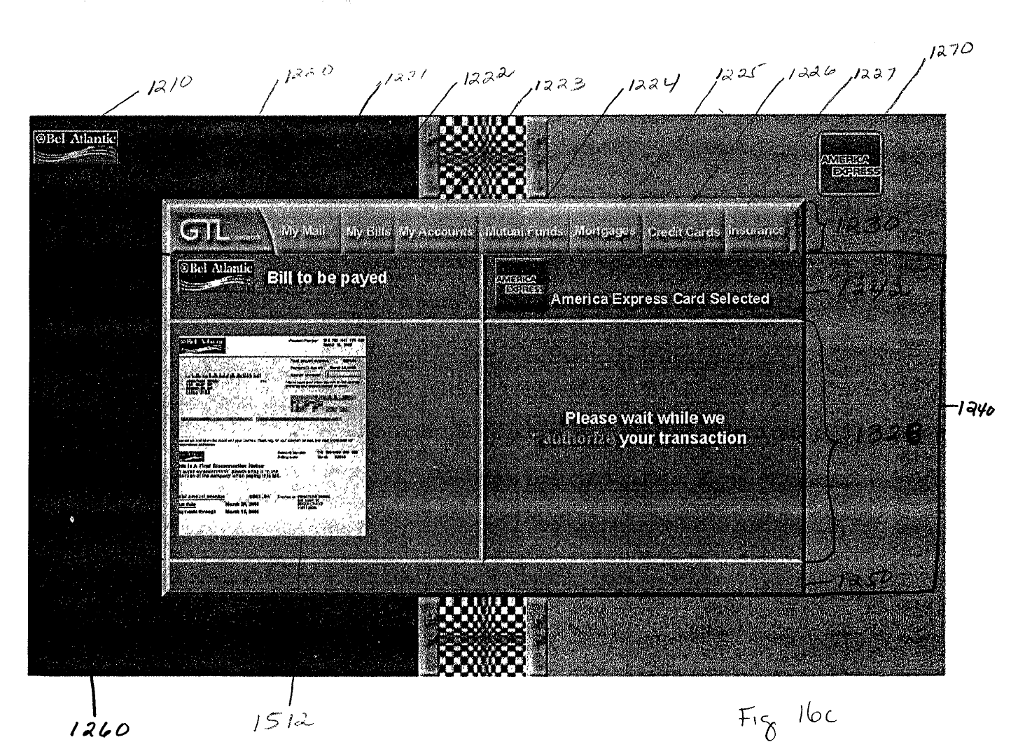

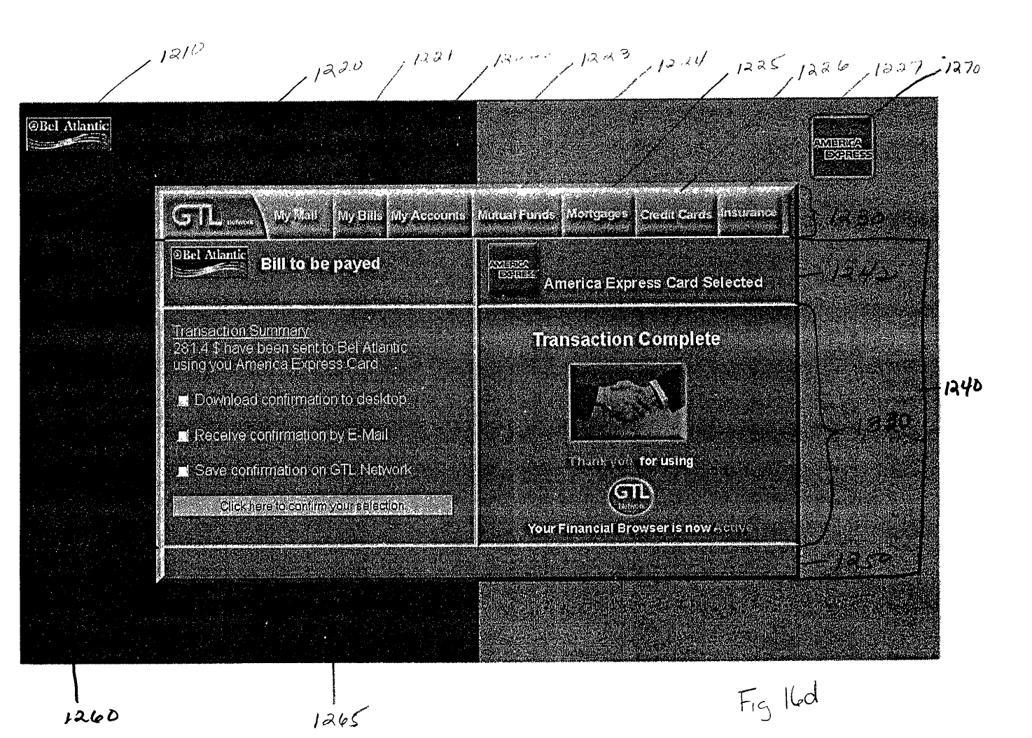

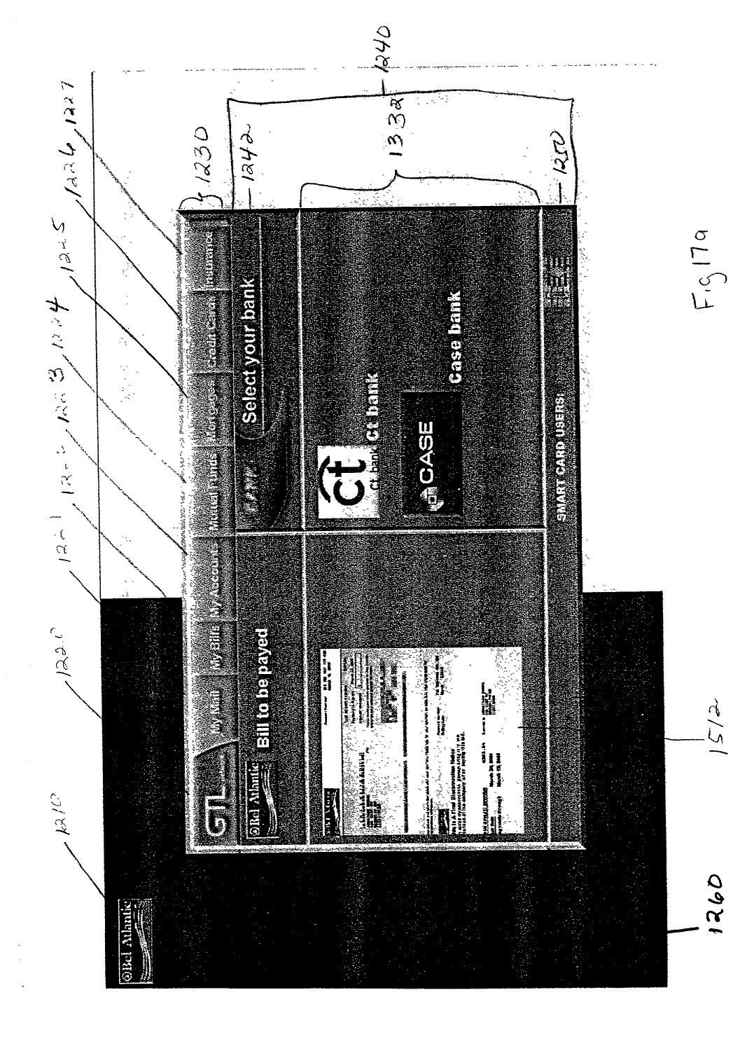

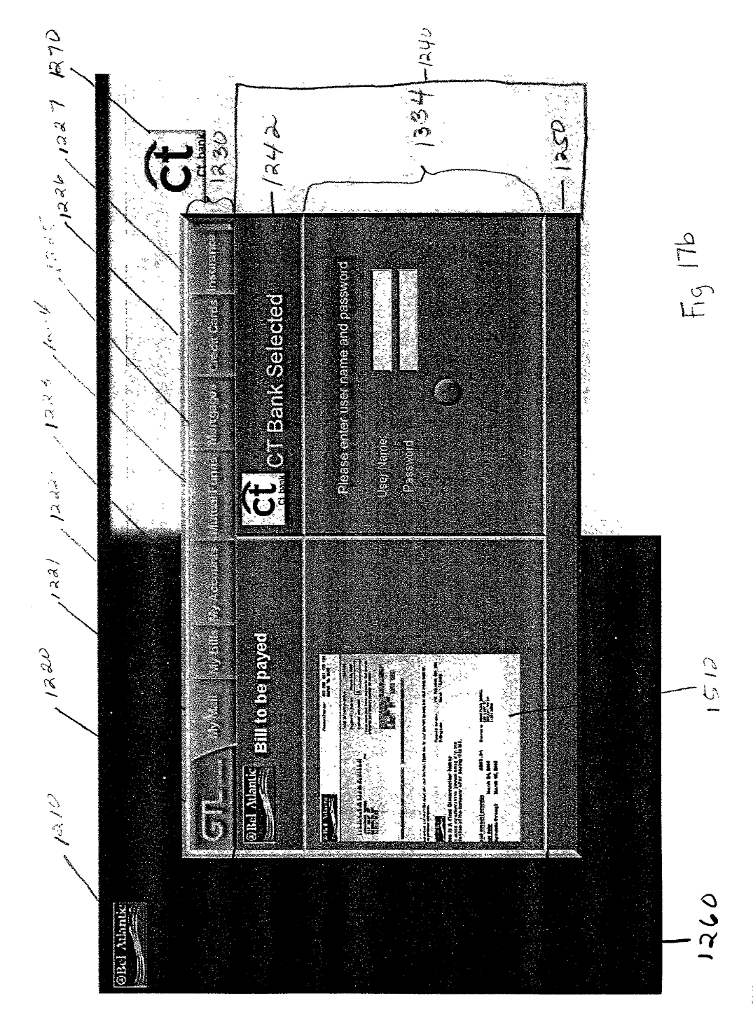

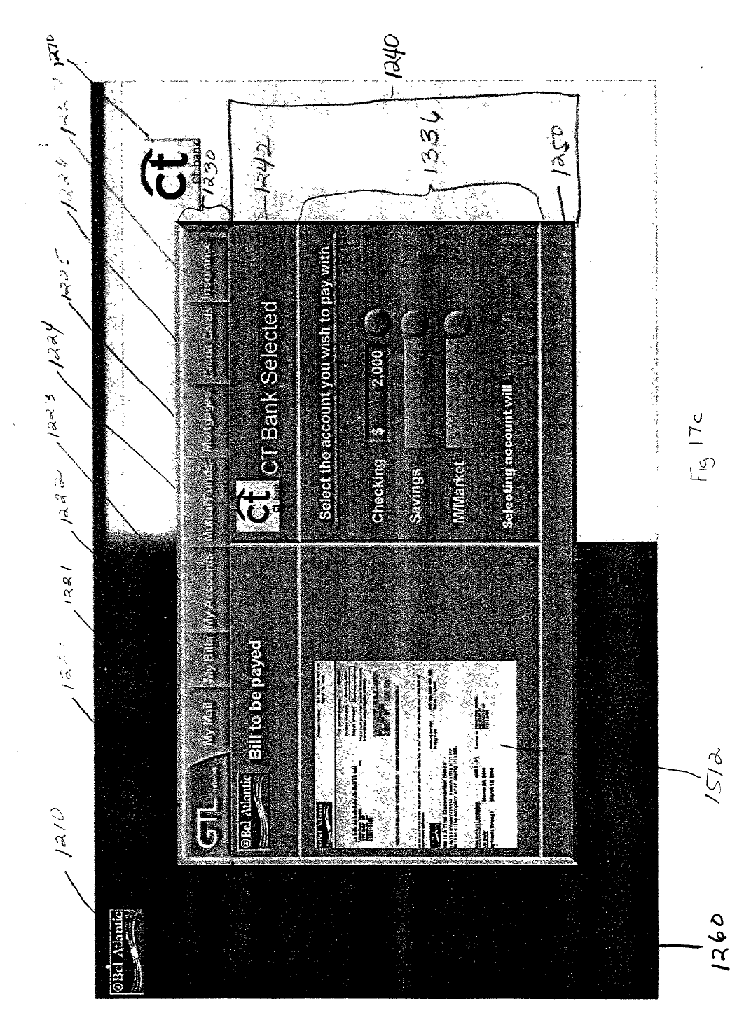

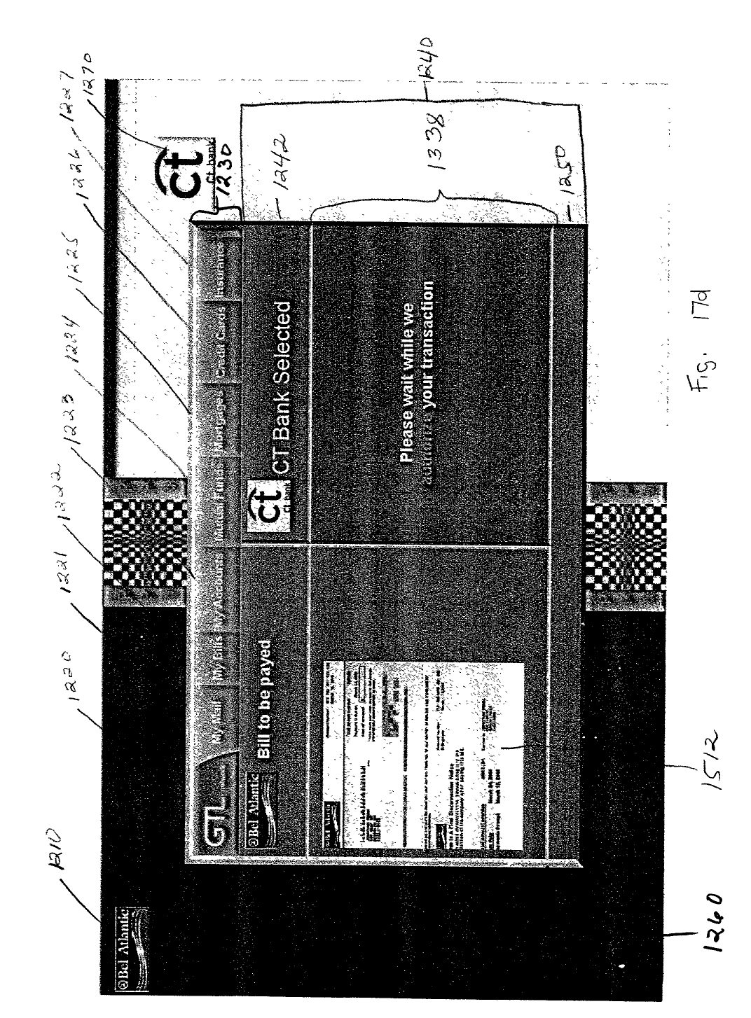

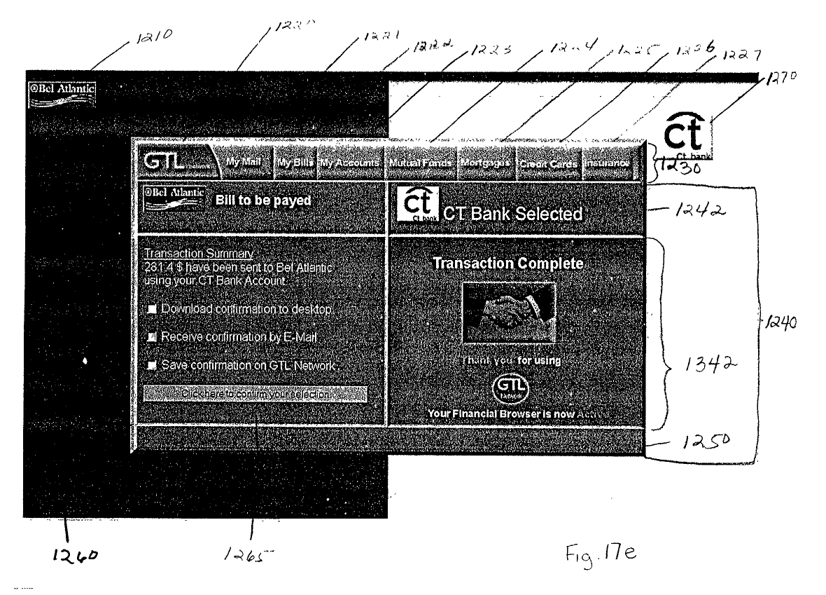

FIG. 15a is a further exemplary bill presentment Web page in accordance with an exemplary embodiment of the present invention. Here, once again, the familiar main transportation server 18 transportation interface is displayed. The system presents the bill 1512 and then two payment options: “My Bank” 1110 and “Credit Card” 1118 may be selected. Should the user chose to withdraw funds from the user's bank account, the system takes the user to FIG. 17a. However, should the user chose to pay for the bill 1512 with a credit card, the system transports the user to FIG. 16a. The latter will be discussed first.

FIG. 16a is an exemplary credit card institution selection Web page accessed by selecting option 1118 in FIG. 15a. FIG. 16a resembles FIG. 13a. However in FIG. 16a , rather than paying an invoice 1265 as in FIG. 13a, here the user is paying a bill 1512. Once again the user is presented with the main transportation server's 18 task bar 1230 and with a list of selectable credit card institutions 1324. Also once again, the smart card is an option for use in conjunction with paying a bill 1260. Once the user selects a credit card, the user is directed to the Web site shown in FIG. 16b.

FIG. 16b is an exemplary credit card institution login Web page. As before, the user logs onto the credit card institution system 1326 by inputting a user name and password. Then the user can pay their bills 1512. Once the bill 712 transaction is complete, the user receives, as in all previous scenarios, a confirmation.

FIG. 16c is an exemplary transaction authorization Web page, similar to FIGS. 12i or 13f. FIG. 16d is an exemplary bill presentment transaction approval Web page. Here the user is given a transaction summary with a set of confirmation options 1265. As seen before, the user can chose to download a confirmation to the desktop or receive an e-mail confirmation or save the confirmation on the main transportation server 18 network.

FIG. 17a is an exemplary banking institution selection Web page accessed from the bill presentment Web page in FIG. 15a. As mentioned above, rather than paying with a credit card, the user can elect to pay using the user's personal bank accounts. Once again, the user is presented first with the bill 1512. Then the user selects from a list of banking institutions 1332. Here again in FIG. 17a, the system presents both a main transportation server task bar 1230 and smart card capabilities 1250.

Once the user selects a banking institution, the user sees the log in screen 1334 of the selected financial institution as in FIG. 17b. The user logs on 1334 to the system by submitting, for example, a user name and password in the screen portion 1334. Next, the user selects the account the user wishes to use to withdraw the funds to pay the bill 1512 in FIG. 17c. Finally, the transaction is authorized in FIG. 17d and the system indicates the transaction's approval to the user as shown in the window 1342 in FIG. 17e.

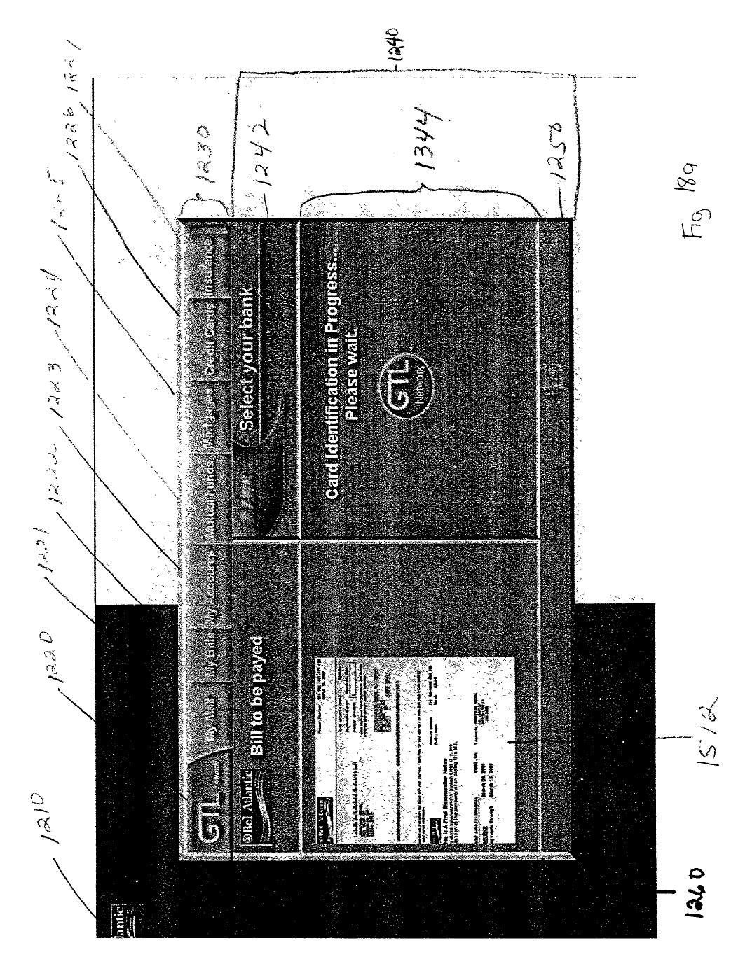

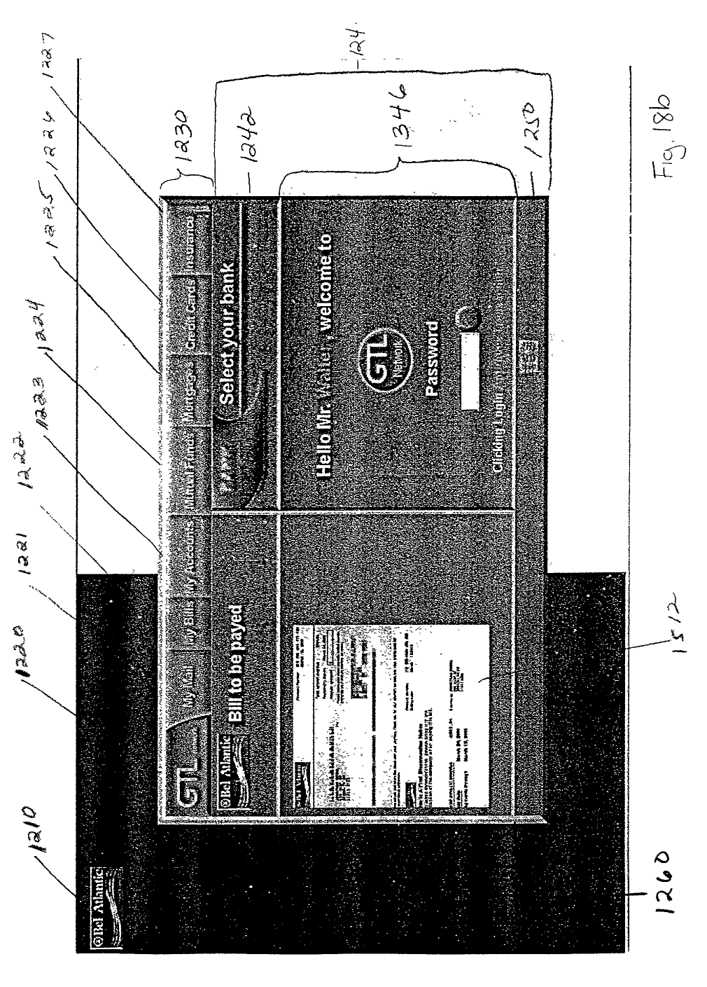

Should the user wish to use a smart card, the user will bypass the login screens as shown in FIGS. 17b and 16b. Instead as shown in FIG. 18a, the user will be identified as shown in 1344 of FIG. 18a and the user will be provided with an additional security measure as shown in the window 1346 of FIG. 18b. For example, the security measure can be the submission of a password.

FIGS. 19a & 19b depict two states of the adaptive security system operated by the guardian modules 12. The first state as shown in FIG. 19a demonstrates legal transaction request server behavior. As shown in FIG. 19a, the series 2 line which represents the current transaction request server behavior closely follows the series 1 line which represents past transaction request server behavior. FIG. 19a represents a typical, normal or authorized transaction request activity.

FIG. 19b represents unauthorized or illegal transaction request activity. As seen in FIG. 19b, the series 2 line does not closely match the series 1 line. In fact, the series 2 line is broken which indicts to the adaptive security system that something is awry. On the basis of the activity in FIG. 19B, a security alarm is activated. At that time, additional security may be implemented and the current transaction is halted. For example, a further password or authentication information may be requested or the user may be contacted by an operator.

While the present invention has been described with respect to a particularly exemplary embodiment, the invention is susceptible to implementation in other ways that are within the spirit of the invention which is defined in terms of the recitations of the appended claims and equivalents thereof.

I claim:

1. An Internet payment system, comprising:
a user device with a processor, Internet connection apparatus and an Internet browser;
a participating merchant server supporting web pages on which product or service offerings are displayed in response to queries from the user device using the connections apparatus and browser, said merchant server interacting with the user device browser to permit a user to select at least one offering and to indicate a method of payment, at least one method of payment being a transfer link;
a participating financial institution server maintained by a financial institution at which the user has a financial account, said server permitting the user to gain direct access to his financial account; and
a main transportation server to which both the user device and merchant server are connected in response to the user selecting the transfer link as the method of payment, the merchant server transmitting information to the main transport server regarding payment required for the selected offering, said main transport server providing a selection of financial institutions from which the user can select an institute at which he has an account for payment for the offering, said main transport server transmitting user inputs directly to the fmancial institution server to authorize payment to the merchant for the offering without storing said inputs.

2. The system of claim 1 further including a participating merchant fmancial institution server, said participating financial institution server executing a real time electronic funds transfer to said participating merchant financial institution server upon said authorization of payment.

3. The system of claim 2 further including a relay server, wherein the electronics funds transfer is via said relay server.

4. The system of claim 2 wherein the funds transfer is by means of virtual money packets.

5. The system of claim 4 wherein the virtual money packets are encrypted before being sent and are decrypted when received.

6. The system of claim 4 wherein confirmation of the transaction is confirmed by the sending of an empty virtual money packet from the merchant's financial institution server to the user's financial institution server.

7. The system of claim 4 wherein the transfer fo the virtual money packet is by way of a relay server.

8. The system of claim 1 in which the main transportation server further transmits confirmation of payment to the merchant.

9. The system of clam 1 in which the user device is a personal computer with a microprocessor and the Internet connection apparatus is a modem.

10. The system of claim 1 in which the user device is a personal digital assistant with a microprocessor and the Internet connection apparatus is a wireless Internet connection.

11. The system of claim 1 in which the main transportation server further includes a firewall.

12. The system of claim 1 in which the firewall of the main transportation server monitors the pattern of activity of the user device and signals an alarm in response to an anomalous pattern of activity.

13. The system of claim 1 wherein at least the financial server and host server have encryption and decryption devices so that transmissions between the host server and the financial server may be encrypted when sent and decrypted when received.

14. The system of claim 1 wherein the information is transmitted as document packets which include routing elements.

15. The system of claim 1 wherein the information is transmitted as document packets which include assembly elements.

16. The system of claim 1 wherein the financial institutions include at least one of banks and credit card companies.

17. The system of claim 1 wherein said main transportation host server supports a link web page which has a first portion that displays the information from the merchant server regarding payment required for the selected offering, and a second portion that displays the selection of financial institutions.

18. The system of claim 17 wherein said link web page further includes a task bar by which the user may call special functions at least at one of said main transportation server and said financial server.

19. The system of claim 17 wherein the second portion of the link web page displays communications to and from the financial server once it is selected.

20. The system of claim 17 wherein the second portion of the link web page indicates when a payment authorization transaction has been completed.

21. An Internet payment method, comprising the steps of:
accessing a merchant web page supported by a participating merchant server over the Internet; said merchant web page displaying product or service offerings in response to queries;
selecting a transfer link least as a method of payment for at least one offering;
connecting to a link web page supported by a main transportation server in response to selecting the transfer link, said link web page displaying information regarding payment required for the selected offering and a list of participating financial institutions;
selecting a financial institution at which a user has a financial account;
gaining direct access to the financial account from the link web page and receiving communications about the financial account on a portion of the link web page; and
authorizing payment to the merchant for the offering on the link web page by communicating with the financial institution and without storing information regarding access to the financial account on the main transportation server or the merchant server.

22. The method of claim 21 further including the step of selecting a method of confirmation of payment to the merchant from the link web page.

23. The method of claim 21 further including the step of inserting a store card in a card reader at a user device, deducting the invoice amount from the store card without selecting or gaining access to a financial account.

24. The method of claim 21 further including the step of inserting a smart card in a card reader at a user device, inhibiting the steps of displaying of a list of participating financial institutions and selecting a financial institution, and gaining direct access to the financial institution associated with the smart card.

25. An Internet payment method, comprising the steps of:
receiving a request for payment to a merchant by a transfer link for a product or service offering, said request indicating the merchant, the offering and the price;
displaying on a link web page the request information and a list of participating financial institutions from which a transfer link payment may be made;
directly connecting a user to a particular financial server in response to a selection, and establishing a direct communications path between the link web page and the financial institution server;
receiving communications about the financial account on a portion of the link web page; and
transmitting over the communications path to the financial institution server authorization to pay the merchant for the offering in response to inputs on the link web page and without storing information regarding access to the financial account.

26. The system of claim 1 wherein at least a portion of said main transportation server is maintained at one of said participating financial institution server and participating merchant server.

27. The system of claim 2 wherein at least a portion of said main transportation server is maintained at one of said participating financial institution server, said participating merchant server, and said participating merchant financial institution server.

28. The system of claim 1 further including a card reader at the user device, said card reader determining whether an inserted card is a store card or a smart card, where a store card is inserted the amount of the invoice is deducted from the store card and the main transportation server confirms the transaction to the merchant without the intervention of a participating financial institution server, and where a smart card is inserted the amount of the user device is connected directly to the participating financial institution server without the main transportation server presenting a list of participating financial institutions to the user.

29. A secure electronic information transportation method, comprising the steps of:
dividing digital information into multiple packets encoded with encrypted marking indicating the packet's original location in the information;
scrambling the generated packets to create a virtual puzzle;
sending the packets to the destination;
receiving the packets at the destination and assembling the information from the packets based on the encrypted markings.

30. The method of claim 29 wherein the packets are sent through at least two separate and randomly selected IP addresses.

31. The method of claim 29 wherein the scrambled packets are encrypted before being sent to the destination.

32. An Internet payment system, comprising:
a user device with a processor, Internet connection apparatus and an Internet browser;
a first participating financial institution server maintained by a fmancial institution at which the user has a financial account, said first financial server supporting web pages on which its customer financial accounts are displayed in response to data from the user device using the connections apparatus and browser, said first fmancial server interacting with the user device browser to permit a user to select at least one of the customer's accounts and to indicate a funds transfer method, at least one method of being a transfer link;
a second participating financial institution server maintained by a fmancial institution at which the user has a second financial account, said second financial server supporting web pages on which its customer financial accounts are displayed in response to data from the user device using the connections apparatus and browser, said second financial server permitting the user to gain direct access to his second financial account; and
a main transportation server to which both the user device and said first and second financial servers are connected in response to the user selecting the transfer link as the method of funds transfer, the first financial server transmitting information to the main transport server regarding funds to be transferred, said main transport server providing a selection of second financial institutions from which the user can select an institute at which he has a second account, said main transport server transmitting user inputs directly to the second financial institution server to authorize the transfer of funds to the first financial institution server for the without storing said inputs.

33. The system of claim 32 further including a card reader at the user device, said card reader determining whether an inserted card is a store card or a smart card, where a store card is inserted the amount of the funds are deducted from the store card and delivered to the first financial institution without connection to the second fmancial institution, and where a smart card is inserted the user device is connected directly to the participating financial institution server without the main transportation server presenting a list of participating financial institutions to the user.
